(19) United States
(12) Patent Application Publication
(10) Pub. No.: US 2009/0195385 A1
(43) Pub. Date: Aug. 6, 2009

(54) Proactive hand hygiene monitoring system

(76) Inventors: Ching Ching Huang, Glendora, CA (US); Jennifer Peng, Huntington Beach, CA (US); Francine N. Hwang, Los Angeles, CA (US)

Correspondence Address: Ching Ching Huang, 949 E. Plymount Stret, Glendora, CA, 91740, US

(21) Appl. No.: 12/217,415

(22) Filed: Jul. 3, 2008

Related U.S. Application Data
(60) Provisional application No. 61/063,496, filed on Feb. 4, 2008.
(60) Provisional application No. 61/063,497, filed on Feb. 4, 2008.
(60) Provisional application No. 61/072,261, filed on Mar. 31, 2008.
(60) Provisional application No. 61/071,433, filed on Apr. 29, 2008.

(51) Int. Cl. G08B 23/00; G08B 13/22

(52) U.S. Cl. 340/572.1; 340/573.1

(57) ABSTRACT

A system consists of remote identification tag (in the form of wristband) for personnel who must undergo hand hygiene frequently during a day's work, programmed soap and rinse-free disinfectant dispensers, entry-exit sensors for controlled access areas and data transfer stations is used to monitor and record every handwashing procedure along with its thoroughness as well as every hand cleaning event with rinse-free disinfectant. The system will further prompt each worker's identification tag at an appropriate place to examine its record to see whether a hand hygiene procedure is required before proceeding to his/her next task. The recorded data with time-date of each event will be transferred to a central computer for statistical analysis and presentation as a daily and/or periodic hand hygiene compliance report on each staff, department, shift and the entire institution.

### RELATED APPLICATIONS

This application claims the benefit of U.S. Provisional Application Nos. 61/063,496 and 61/063,497 filed on Feb. 4, 2008; 61/072,261 filed on Mar. 31, 2008 and 61/071,433 on Apr. 29, 2008.

### FIELD OF THE INVENTION

This application relates to the hand hygiene monitoring system that can identify the personnel, the frequency of his/her handwashing and hand cleaning with rinse-free disinfectant as well as the thoroughness of his/her handwashing effort each time. By using an identification tag to collect the handwashing and cleaning data, it will proactively remind the wearer to undergo handwashing or cleaning as required to reduce propagation of infection. Furthermore, by using a unique identification method to accurately link the person conducting a hand hygiene event and by further linking all the identification tags with a central data processor, this invention can accurately report the compliance of workers to the hand hygiene guidelines issued by many governmental agencies and institutions, such as hospitals, nursing care facilities, outpatient clinics, food processing/delivery entities to reduce the incidences and costs resulting from cross infection by unclean hands.

### BACKGROUND OF THE INVENTION

According to the publications of U.S. Center for Disease Control and Prevention (CDC), more than 2 million patients annually are inflicted in U.S. hospitals with hospital acquired infections (HAI), such as methicillin-resistant Staphylococcus aureus (MRSA), vancomycin-resistant Enterococcus (VRE), Clostridium difficile, etc., and every year more than 80,000 patients (one every 6 minutes) die from these complications. More than 36 billion dollars loss a year can be attributed to HAI, and this number does not count the suffering of the patients and liability law suits.

The U.S. Department of Agriculture estimates that annually more than 79 million Americans suffer from food born illnesses due to infectious germs, like, E Coli salmonella, hepatitis, etc., and hundreds of thousands require hospitalization. Again, billions of dollars in medical expenses and loss of business resulted yearly. Similar conditions occur in the hotel, spa, fitness center and cruise line industries, where infectious germs are propagated by clients and staff unknowingly through contacts or unclean surfaces.

The single most effective mean to stop or greatly reduce the cross infections, according to the CDC and the World Health Organization (WHO) after years of research and studies, is proper handwashing. Lately, the CDC has added hand cleaning with rinse-free disinfectant such as alcohol or alcohol gels as an effective alternative to handwashing to reduce the frequency of time-consuming handwashing procedures and therefore to improve hand hygiene compliance. Both organizations had issued comprehensive guidelines to healthcare workers and those working in the food processing and delivery industries as well as to the public on what constitutes as proper handwashing steps and hand cleaning to achieve effective killing of both transient and resident germs on hands to reduce cross infection.

However, even with all healthcare workers, especially physicians, having the common knowledge as well as the education and training that having clean hands is the key in reducing infection propagation, most of them do not conduct hand hygiene procedures at the thoroughness and frequency required. Without human monitoring, only 15% of doctors and 35% of nurses comply with the hand hygiene guidelines established by CDC for hospitals. Knowing someone is monitoring them, the percentage increases to around 50%. Worst of all, the intensive care units in hospital typically have the worst hand hygiene compliance record.

Many studies had been done by government agencies and hospitals to understand why the low compliance by the healthcare staff. Some tangible reasons were heavy work load, inconvenient location of wash basins, skin irritation and dryness due to frequent handwashing, the misconception of wearing gloves would eliminate the need of hand hygiene, etc. Very few cited lack of education, training or comprehension of the importance of hand hygiene in HAI reduction.

With those studies in mind, virtually every hospital has undergone improvements such as addition and relocation of wash basins (making handwashing convenient to all staff), addition of numerous rinse-free disinfectant dispensers in hallways and in patient rooms facilitating each staff member to clean his/her hands before handling a patient, increasing and strengthening periodic education session(s) emphasizing the importance of hand hygiene in reducing HAI and instituting extensive human monitoring. Yet the compliance rate only showed limited improvement when extensive and long term human monitoring was carried out.

This outcome clearly points to three critical factors toward increasing the hand hygiene compliance by healthcare workers:
(1) continuous monitoring is a must;
(2) timely reminder to the staff members to clean hands;
(3) the monitoring process must not create additional work for healthcare workers or interrupt their busy work routines.

In the restaurant and food processing industry, the situation is worse. It can be best summarized by a scene from the sitcom “Seinfeld”, whereas Jerry Seinfeld was in the restroom of a restaurant washing his hands when the chef came out of a toilet stall, smiled and just casually said “Hi Jerry! I am going to prepare your favorite dish.”, then promptly walked out of the restroom without stopping to wash his hands. Most restaurant or food processing plant workers will just casually rinse their hands after using the rest rooms or handling raw meats, thus introducing of E. coli, salmonella, hepatitis, etc. to unsuspecting customers. Not only do customers suffer physically and financially, but enterprises also receive severe economic loss due to sharp decline of business and long term damage to their brand reputation.

At the present, there is only the periodic inspection by health inspectors of local municipalities, which simply cannot improve the adherence to hand hygiene guidelines by food processing/delivery workers. Therefore, a constant monitoring system is necessary to assure improvement in hand hygiene practice in this industry sector besides regulations and occasional inspections.

Besides these three criteria on the requirements of a hand hygiene monitoring system mentioned above (continuous monitoring, timely reminding and not interrupting the regular work routine), there is one additional feature that is just as critical in healthcare settings and food service places to implement such system-the accuracy of its reporting. If a person can be potentially mis-identified, then the accuracy of the hand hygiene report is in doubt and no worker will likely accept such monitoring, especially if his/her employment or compensation status is linked to such a monitoring system.

To identify a person correctly, a unique personal identification code will be assigned to a person and encoded into an identification tag to be carried by that person. To achieve no additional steps to a regular work routine, a hand hygiene monitoring system will want to use remote reading of an identification tag to avoid handling of that ID tag with dirty hands, such as a step of swiping an ID tag through a reader (in magnetic strip type) or placing at some fixed position in front of a reader (in optical bar code type).

Radio Frequency Identification technology (RFID) has been used extensively in encoding personnel identification tags. There are two types of RFID: (1) the passive transmitter type which does not have an internal power source to broadcast its identification code and requires charging electromagnetically to achieve transmission of its ID codes, i.e. the ID tag must be placed close to the reader with such charging antenna; (2) the active transmitter with built-in battery to continuously broadcast its ID codes for a reader to decode.

The passive RFID type (commonly used by credit/debit cards for retail transactions) is not suitable for a hand hygiene monitoring system, since it will require the wearer to handle his/her ID tag and place it close to a RFID reader. For a healthcare worker, this extra step will mean he/she handles the ID tag at least 10 to 20 times an hour and usually with unclean hands.

By using the active RFID type, the ID tag transmitting its unique ID code at a frequency (such as at 2.4 GHz) can be read at a distance by the reader tuned into the same frequency, thus eliminating the extra step of bring the tag to the close proximity of a reader. However, when a RFID reader is located in a wash basin (either integrated into a soap dispenser or being an independent unit by itself) with several persons wearing active RFID tags standing in front of the basin or walking nearby, the reader will record the ID codes of all those tags and unable to distinguish who is the person actually doing the handwashing. Alternative technology such as frequency hopping to enable the reader/detector to detect up to several thousand unique ID signals each at slight different frequency will read/detect all the ID tags within its range in a second. However, this reader/detector still can not distinguish who the person is actually doing the handwashing. Same situation arises for worker wearing active RFID tag to use a rinse-free disinfectant dispenser to clean his/her hands. A reader will very likely make mistakes in identifying the person undergoing hand cleaning procedure when more than one person is around or just walking by the dispenser.

The invention described here provides the simplest means of accuracy in identifying the person conducting the hand hygiene event.

There are several hand hygiene or handwashing monitoring systems commercially available (such as iHygiene by Woodward Laboratories, Aliso Viejo, Calif., HyGenius by Compliance Control, Inc., Landover, Md. and Pro-Giene system by UltraClenz, Riviera Beach, Fla.) as well as many prior patents and patent applications (cited below) describing how to perform the hand hygiene monitoring in parts or in whole. Yet the fact is very few systems have been accepted into the healthcare settings, restaurants, food processing plants, etc. The two main reasons are: (1) they disrupt the regular work routine of a place, and (2) they lack unequivocal accuracy in identifying the personnel.

A set of prior arts (cited here in chronological orders—U.S. Pat. Nos. 5,202,666, 5,610,589, 5,793,653, 5,900,067, 5,945,910, 6,236,317, 6,392,546, 6,727,818, 6,882,278, and 6,975,231) describe a variety of hand hygiene monitoring systems. All of them will register which person has performed handwashing procedure. Some of these prior arts fail to describe how their systems identify the person conducting the handwashing or cleaning; while others dictate that added steps by persons wearing the identification tags to register their tags with the monitoring device (such as swiping through a magnetic reader or placing close to a radio frequency (RF) reader) to assure proper recording the identify of whom is undergoing the handwashing or cleaning. For those using active RFID or implying its usage (U.S. Patent Application No. 2007/0257803 and 2008/0001763), however, none puts forward a method of correctly identifying the person undertaking the hand hygiene procedure when others are around a wash basin or a rinse-free disinfectant dispenser. Without this accuracy, any monitoring system will be useless in its stated purpose.

Also, none of these arts stipulated a method of distinguishing the persons when 2 or more people dispensing soap or rinse-free disinfectant sequentially within a few seconds from one another at a single wash basin or rinse-free disinfectant dispenser (such as during a shift change). Furthermore, multiple persons' presences in a patient room, such as in a teaching hospital during a doctor's round with several students in tow, creates the necessity of correctly identify the hand hygiene status of each person. These are the critical situations a monitoring system must handle accurately to be useful, but none of them were addressed by the prior arts cited.

Since every worker prefers to be reminded on performing a hand hygiene procedure prior to certain tasks rather than just being given a negative grade for forgetting to do so, it is essential for the monitoring system to be able to provide timely proactive prompts to remind the worker instead of just recording the failure. Furthermore, the prompts should be unobtrusive, so they will not embarrass the workers or disrupt the working relationship with customers or between patients and their care takers. Many of the commercial systems and prior arts use flashing beacons and audible alarms as reactive prompts, thus totally destroying the chance of acceptance by workers as well as reducing its effectiveness to nothing. The proactive prompting of this invention fulfills the purpose of reminding a worker to conduct hand hygiene on a timely and unobtrusive manner, but also repeat the reminder to assure compliance rather than simply recording a failure to do hand hygiene as required.

### SUMMARY OF THE INVENTION

This invention describes a proactive hand hygiene monitoring system that utilizes:
(1) An intelligent identification tag (can be in the form of a wrist band or an foot ankle band) assigned to each personnel to be monitored, which uses active RFID or a combination of passive and active RFID technology to interact with pre-programmed soap and rinse-free disinfectant dispensers as well as entry-exit sensors to record the time-date of each of this person's hand hygiene event and its thoroughness. Based on the ID tag's record and notification from an entry-exit sensor, it will also proactively prompt (by either vibration or low tone) the wearer to conduct hand cleaning prior to perform the next task, such as handling next patient or after handling raw meat.
(2) Pre-programmed soap and rinse-free disinfectant dispensing (wall-mounted and/or counter top placed) units which will notify a user's ID tag via radio frequency of the dispensers' own unique identification codes after triggering by that user's ID tag.
(3) Entry-exit sensors which will detect the entering into or exiting from a controlled access area of one or more persons and inform each person's ID tag via radio frequency to record the time-date of the unique identification codes of the sensor as well as prompting each ID tag to check the last time of hand hygiene event of the wearer to determine whether a prompt for hand cleaning is required.
(4) Data transfer stations which will download the recorded data from every personnel ID tag placed on their slots. They will verify the data integrity and convert them into a proper format (such as TCP/IP for Ethernet) for transmission to the central data processor (computer). They will also charge the internal battery of an ID tag to maintain its functionalities.
(5) A central computer (which can be a personal computer or a server) which will receive the collected data from all the data transfer stations and processing them into a daily and/or periodic hand hygiene compliance report. It will also query the maintenance conditions of each component of this system (such as soap and rinse-free disinfectant refills as well as battery power level) and perform diagnostic to detect any malfunctions. During the data collection process, it will synchronize its clock with all the ID tags to assure the entire system is in synchronization with respect to timing of all events. It will also archive all the collected data and information.

By using appropriate electronics and instruction sets, this invention delivers a hand hygiene monitoring system that provides:

(1) continuous monitoring,

(2) timely unobtrusive reminder to the staff to wash or clean hands,

(3) no disruption to the regular work flow or handwashing procedure,

(4) absolute accuracy in identifying a person undergoing handwashing or cleaning.

It is a system that can deliver the performances demanded by healthcare settings, food services, hotels, cruise ships, spas and fitness/gyms to minimize cross infection by staff due to lack or improper hand hygiene.

### BREIF DESCRIPTION OF THE DRAWINGS

The following drawings describe the invention in one of its hardware configurations, associated software instruction sets, associated unique methods to identify a person undergoing the handwashing and cleaning (with rinse-free disinfectant) events as well as how the system proactively prompts a person to clean his/her hands to comply with hand hygiene guidelines set down by CDC and/or an institution. Also locations and circumstances which the components of this invention can be used are illustrated.

FIGS. 1 illustrates four of many configurations that a soap dispenser may take. FIG. 1a is a wall-mounted soap dispenser (marked by the number 1) with an infrared proximity sensor located at the bottom of the unit (2) to sense the presence of hand(s) to trigger the dispensing of soap aliquots. This method of triggering the dispensing mechanism is termed “touchless”. FIG. 1b is also a wall-mounted unit, but the soap is dispensed by depressing the front tab (8). There is no infrared proximity sensor for hand. This is an alternative method of triggering soap dispensing (called manual). The controller and RF circuitries of the soap dispenser are activated by either the signal from the infrared proximity sensor (2) or the contact made through the action of the tab (8) depression. FIGS. 1c and 1d show a manual version of soap dispenser in counter-top mounting configurations (on top or beneath the counter) with the dispensing tab and the nozzle integrated into a single package (9). Any one of these four configurations of the soap dispensers can be installed at a location next to a wash basin as shown.

FIG. 2 presents two wall-mounted versions of rinse-free disinfectant dispensers. They are typically mounted along hallways or passageways and within controlled access areas (such as patients' rooms) where workers can access disinfectant quickly to clean their hands.

FIG. 3a provides one of the package designs for entry-exit sensor (13) which is mounted above the interior of a door frame (14) as an example; while FIG. 3b details the two pulsed infrared emitter/detector cones (15, 16) aiming out at a slight angle from each other to detect entry or exit.

FIG. 4 shows two potential packages of ID bands/watches that can be employed for this invention. The controller, RF circuitry and internal rechargeable battery (along with the watch component, if used) will be encapsulated in either water-proof metal or plastic housing, while the antenna portion can only be in a plastic housing. The band can be made of leather, plastic, fabric or metal.

FIG. 5 illustrates two configurations for the data transfer station. One configuration is a multiple-port version (18) where workers can place their ID bands for downloading stored hand hygiene data and charging internal battery after work shifts are completed. Each port has an LCD panel (19) that displays the ID band owner's name, so later he/she can pick up the correct ID band without error. The data downloading between the station and individual ID band is done via wireless RF transceiving to eliminate the need of physically connecting an ID band into a port.

FIG. 6 shows the conceptual functional blocks of an ID band interacting with the functional blocks of a pre-programmed soap dispenser during a handwashing procedure.

FIG. 7 illustrates the handwashing sequence with 4 drawings. FIG. 7a represents sensing the presence of a person's hand beneath the soap dispenser; 7b shows the reading of the ID code of the person wearing the ID band; 7c shows the monitoring of handwashing thoroughness, and 7d illustrates the recording of the handwashing event along with time-date and thoroughness grade.

FIG. 8 shows the conceptual functional blocks of an ID band interacting with the functional blocks of a pre-programmed rinse-free disinfectant dispenser during a hand cleaning procedure. The sequence includes sensing the presence of a person's hand, dispensing the disinfectant, transmitting the dispenser ID code with the person's ID code as the lead element, and records the hand cleaning event with time-date in the person's ID band.

FIG. 9 illustrates the conceptual functional blocks of an ID band reacting to the transmission signal generated from an entry-exit sensor when a person either enters or exits a controlled access area. The accompanied drawings demonstrate (a) upon entry, the ID band is notified to examine its stored hand hygiene record, (b) how an ID band produces prompts after examining its record and determining hand cleaning is required, (c) recording the sequence of this event along with time-data in the ID band.

FIG. 10 shows the process block diagram of how the stored data in a person's ID band is transferred through the data transfer station to the central computer.

FIG. 11 shows how a daily hand hygiene compliance report may look. This basic form can be used to monitor the compliance by individual worker, by department and by shift as well as the link with other data sources and software packages to evaluate work flow, work load and tracking the propagation of cross infection.

FIG. 12 provides a conceptual daily maintenance report for maintenance staff to do the soap, rinse-free disinfectant, lotion and paper towel refills, replacing battery and/or any malfunctioned components of the monitoring system.

### DETAILED DESCRIPTION OF THE INVENTION

In the section of “Background of the Invention”, we have pointed out the great need of a hand hygiene monitoring system in many industries to prevent HAI, community acquired infection (ranging from MRSA to influenza to hepatitis) and other types of cross infection. We also described from the numerous studies that such a monitoring system must provide non-intrusive and accurate monitoring to be acceptable to the various institutions. Furthermore, this monitoring system must not add any extra steps to the regular work routines as well as to the standard hand hygiene procedures to assure the workers' willingness to comply. Costs, ease of installation and implementation as well as non-interference to the operation of existing equipment (both in RF and electrostatic interferences), particularly in the hospitals, are also factors that determine the usefulness and the ready adoption of such system.

The invention presented here (using a sample system configuration) accomplishes all these criteria by the following hardware configurations, operating software, implementation and execution procedures:

### 1. Proactive Hand Hygiene Monitoring System Implementation

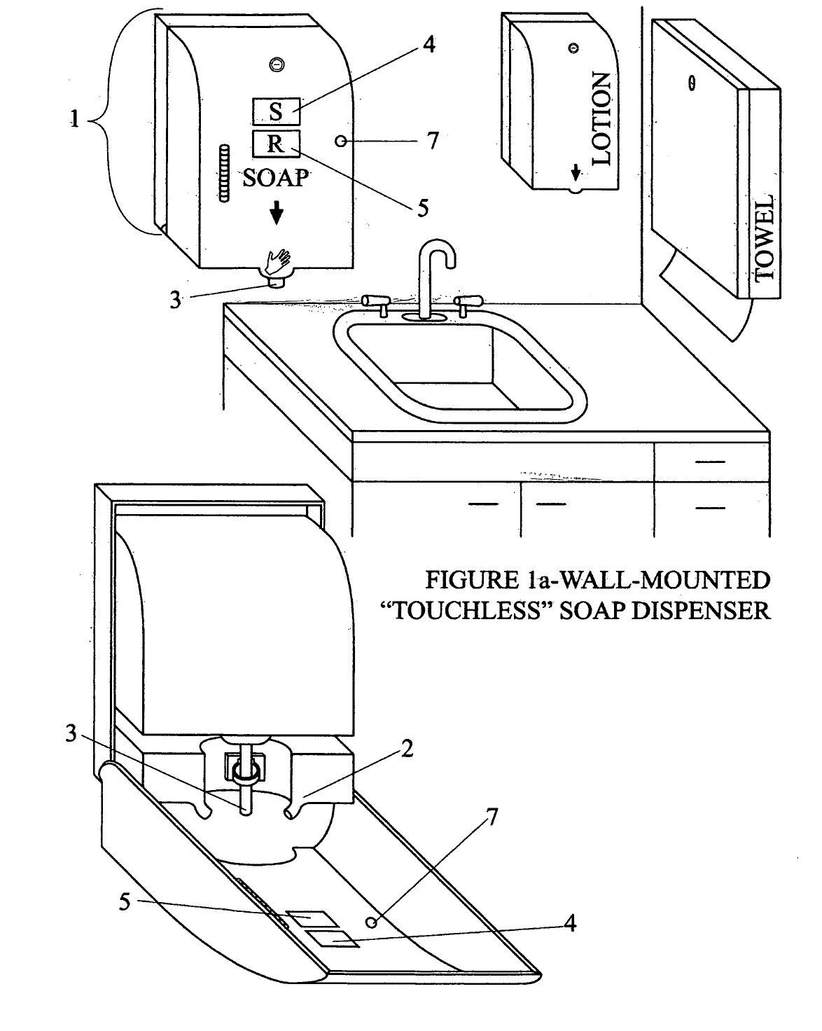

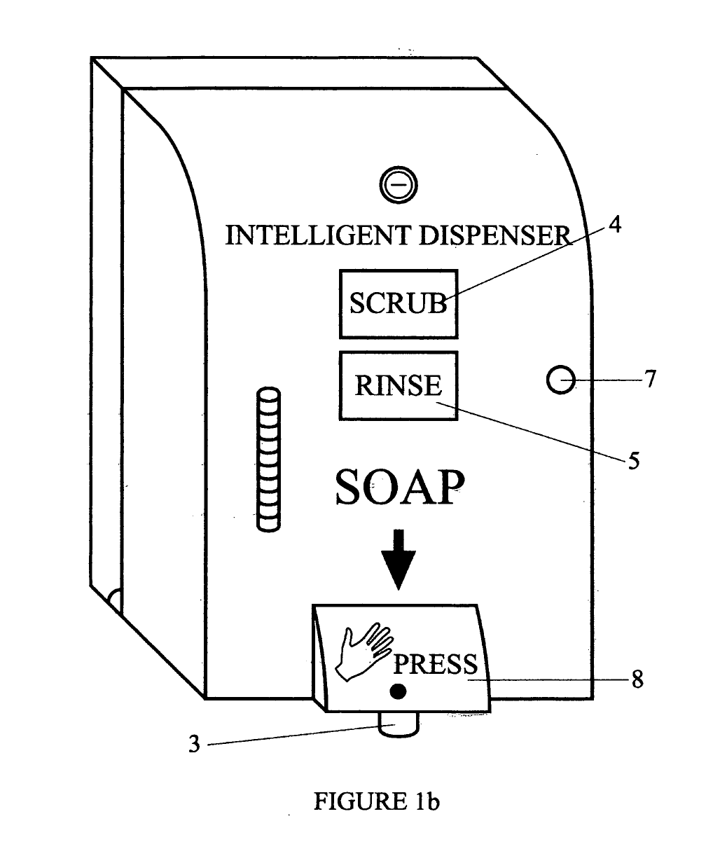

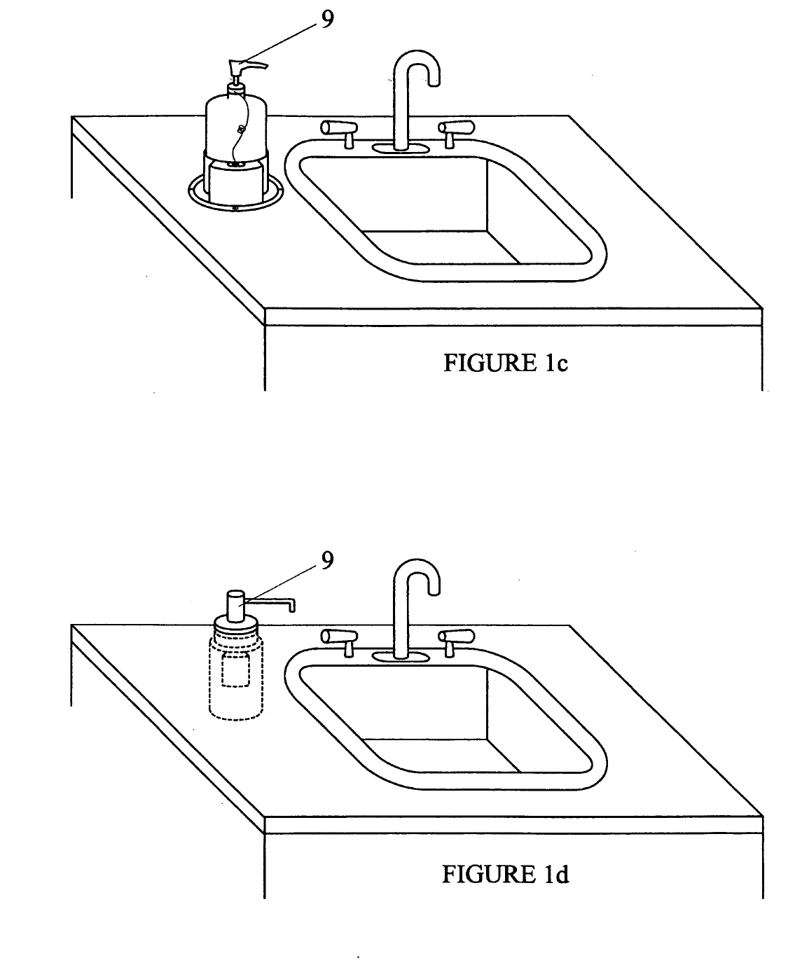

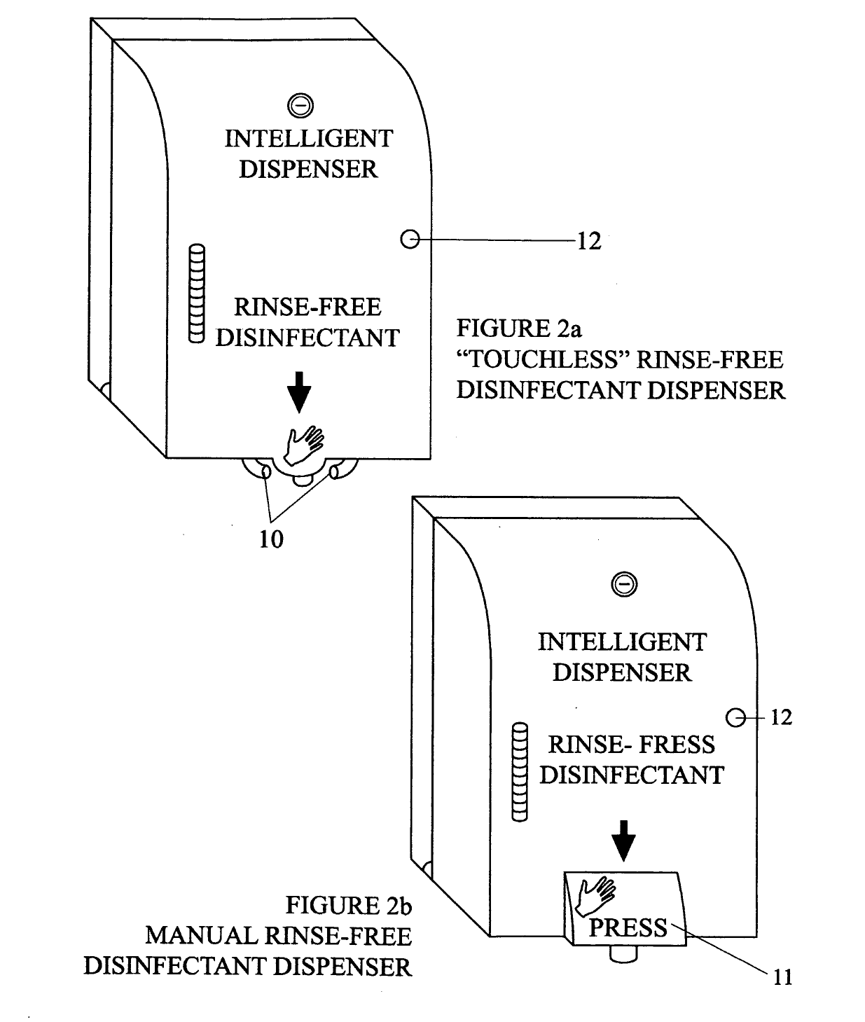

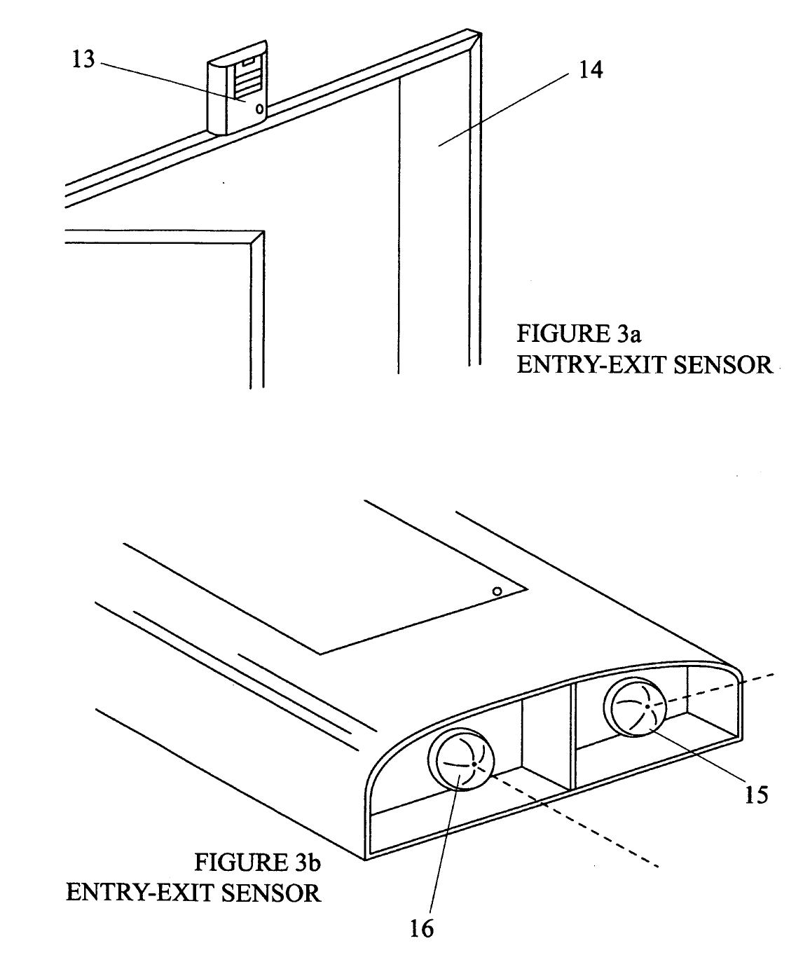

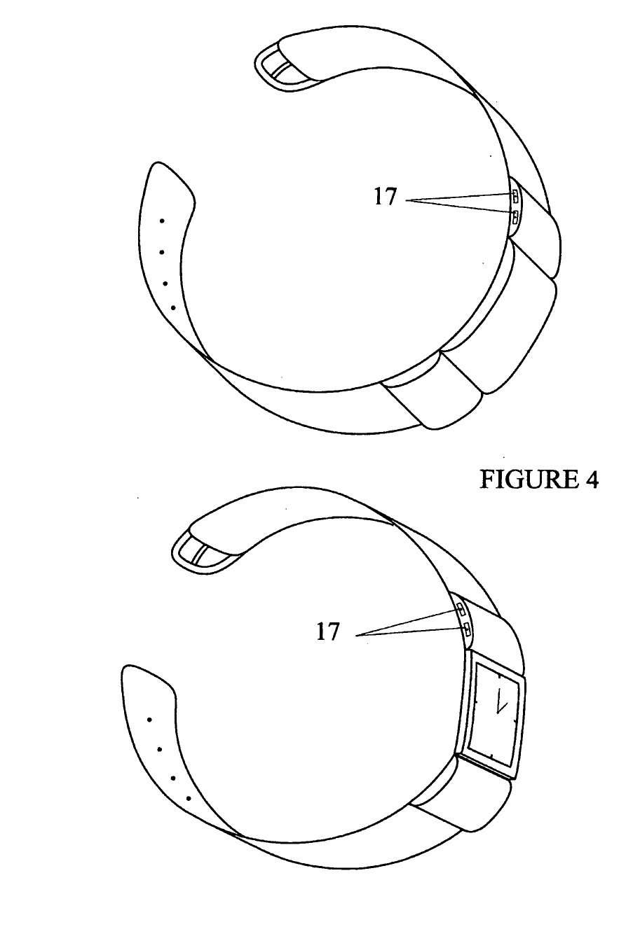

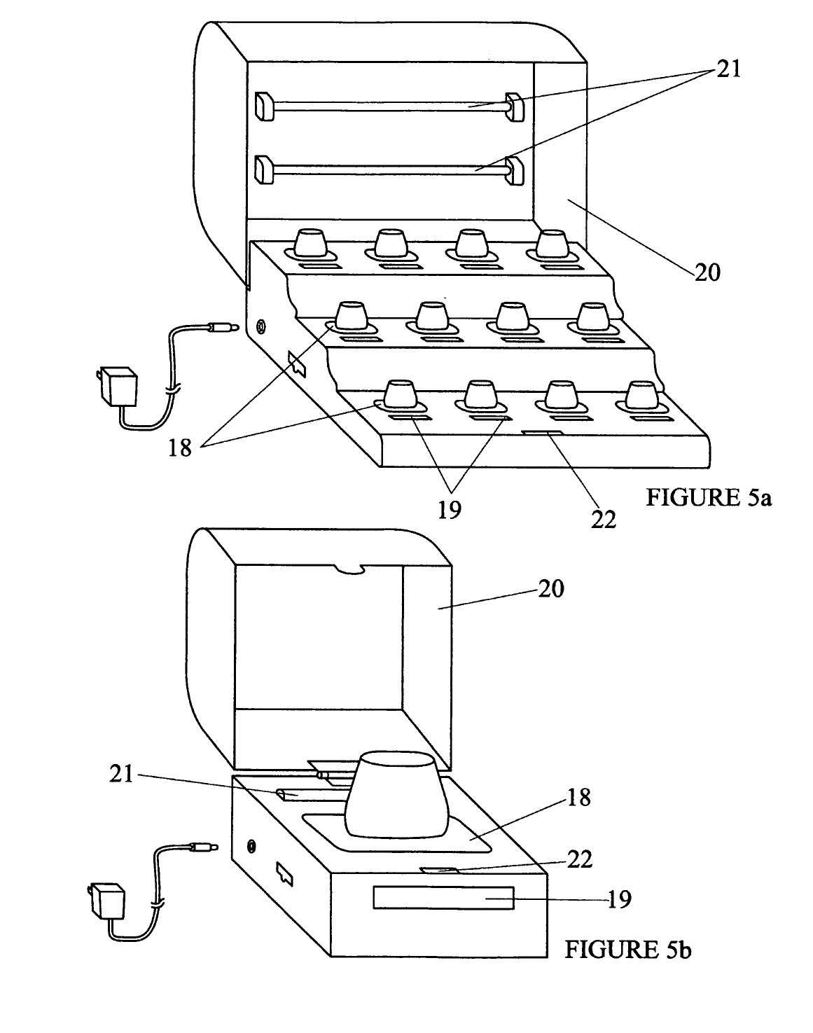

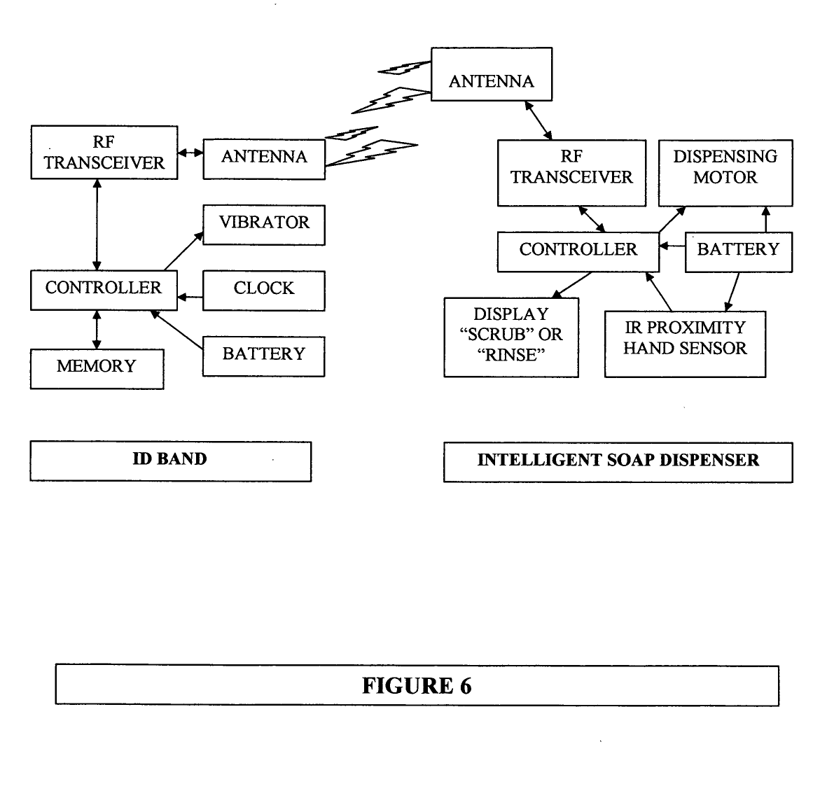

(1) “Touchless” or manual version of pre-programmed soap dispensers (as illustrated in FIGS. 1a, and 1b) will be wall-mounted (or placed in a fixed holder on top or beneath of a wash basin counter as in FIGS. 1c and 1d) next to all wash basins throughout the facility where handwashing will be performed by workers. Each soap dispenser will be programmed with a unique identification code, which represents its type (soap dispensing) and its location in a master program residing in the central computer. The soap dispenser has an intelligent controller and a RF transceiving (both transmitting and receiving) circuitry. It is activated either by the detection of the presence of a hand through its infrared proximity sensor (2 in FIG. 1a), therefore making it a “touchless” version of dispenser or through the manual depressing of the dispensing tab (8 in FIG. 1b). A fixed amount of soap aliquot (between 1.5 to 2 ml) will be dispensed on to hand(s) through the nozzle (3 in FIGS. 1a and b) located underneath the dispenser. On the manual version mounted on top or beneath a counter, the dispensing tab and the nozzle is combined (9 in FIGS. 1c and 1d).
(2) “Touchless” or manual version of pre-programmed Rinse-free Disinfectant Dispensers (as shown in FIG. 2a and b) will be wall-mounted along hallways and within controlled access areas, such as in patient rooms, at locations convenient to workers. Each rinse-free disinfectant dispenser will be programmed with a unique identification code, which represents its type (rinse-free disinfectant dispensing) and its location in a master program residing in the central computer. The rinse-free disinfectant dispenser has an intelligent controller and a RF transceiving circuitry. It is activated either by the detection of the presence of a hand through its infrared proximity sensor (10 in FIG. 2a, thus “touchless”) or through the manual depressing of the dispensing tab (11 in FIG. 2b).
(3) Entry-exit sensors (13 in FIG. 3a), each will be mounted above or at head-height on the inside of a door frame (14 in FIG. 3a) of a controlled access area, such as a patient room, restroom, surgical operating room or counter-top where raw meat is processed. Each sensor will be assigned a unique identification code indicating its location as recorded in a master program residing in the central computer. The sensor consists of two parts: (a) two pulsed infrared emitter-detector sets (15 and 16 of FIG. 3b), which have slight angles in the aiming of their respective detection cones, e.g. one viewing straight downward (when the sensor is mounted on top of the door frame) and one at a small angle away from the vertical beam aiming inside of the room; (b) a RF transmitter circuitry with a controller. This will transmit a signal indicating its triggering is due to entry or exit of personnel as well as its sensor identification code.
(4) Each worker that requires hand hygiene monitoring will be assigned an ID band (as illustrated in FIG. 4) to be worn on the wrist that receives the soap or disinfectant aliquot from dispensers. Each ID band will have its unique ID code indicating the name of the person, department and shift. This code will be part of the master program residing in data transfer stations and the central computer.
(5) Data Transfer Stations (two configurations as presented in FIGS. 5a and 5b) will be allocated to offices, locker rooms and centrally located work areas to facilitate the workers to place their ID bands in it to download the stored data to the central computer. Each station is also assigned a unique identification code to indicate its location in the master program residing in the central data processor.
(6) The central computer is interconnected with all the data transfer stations via an existing network of the facility or via network formed by the alternating current power lines within the facility or via a wireless network. The central computer will collect all the hand hygiene data from all individual ID bands through the data transfer stations and process them into daily/periodic hand hygiene compliance report.

### 2. Handwashing Monitoring

A person wearing his/her ID band undergoing a handwashing procedure will place his/her hand wearing the ID band under the soap dispenser to trigger its infrared proximity sensor (2 in FIG. 1a) for activating the dispensing motor as well as the intelligent controller board. The active ID band will be transmitting at very low power (in 1 to 3 microwatts range, thus the signal can only be read by a dispenser's RF transceiver circuitry at no greater than 10 inches in distance) a data string containing its personnel ID code and the last time the wearer performed a hand hygiene procedure at 2 Hz or faster repetition rate continuously.

While the dispensing motor is turning (or during the depressing of the manual dispensing tab-8 in FIG. 1b), the intelligent controller board of the soap dispenser is activated to receive the personnel ID code from the ID band along with the data of the most recent handwashing or cleaning of the wearer. If two different people place their hands (which is not very likely) within 10 inches of the soap dispenser at the same time, the controller board will select the ID code belonging to the person with longer time lapse from his/her last hand hygiene event. The controller board then adds this personnel ID code as the lead element to its own dispenser ID codes and transmits back to the ID band. This transmission is at higher power (in 2 to 3 milliwatts range) and at 2 Hz or higher repetition rate for a duration of 2 seconds to enable an ID band to receive this signal at a distance up to 4 ft. Any other person wearing an ID band standing next to the person who just dispensed soap or walking by within the 4 ft radius will not be able to decipher the identification code of the soap dispenser, since it does not have the same personnel ID code as the lead element. The ID band of the person undergoing the handwashing procedure will record the identification code of the soap dispenser along with the time-date from its internal programmable clock circuitry as the first piece of data constitutes a handwashing event record.

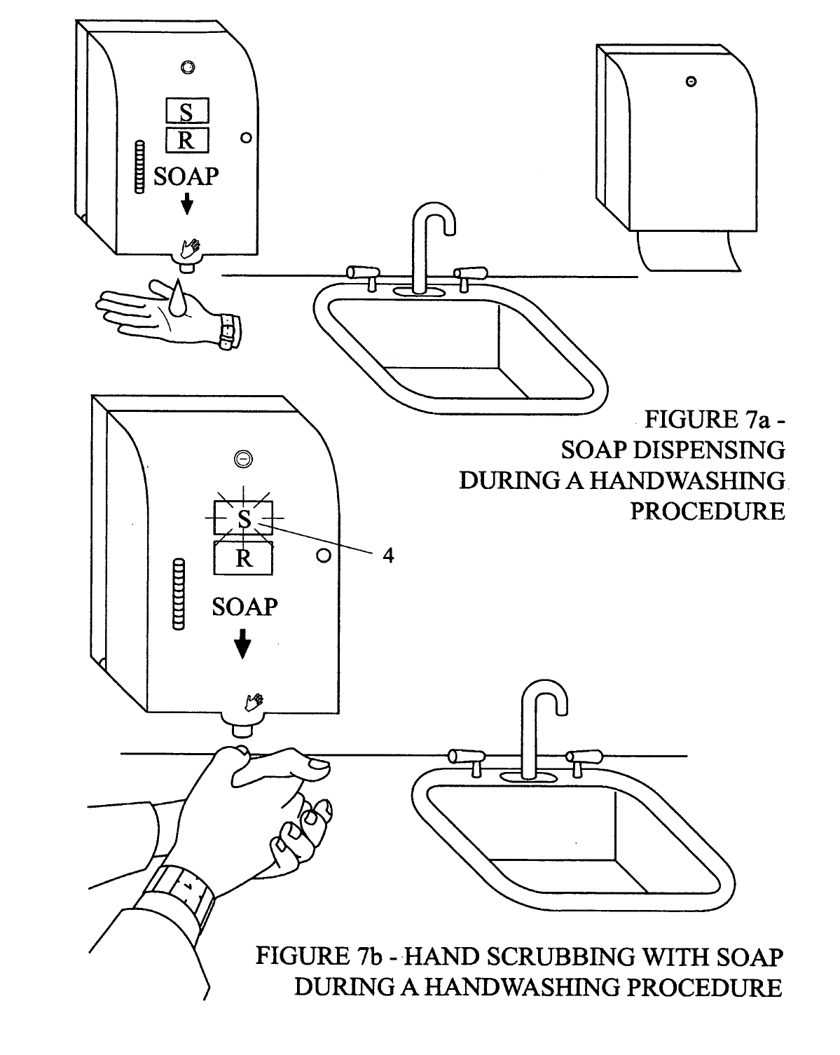

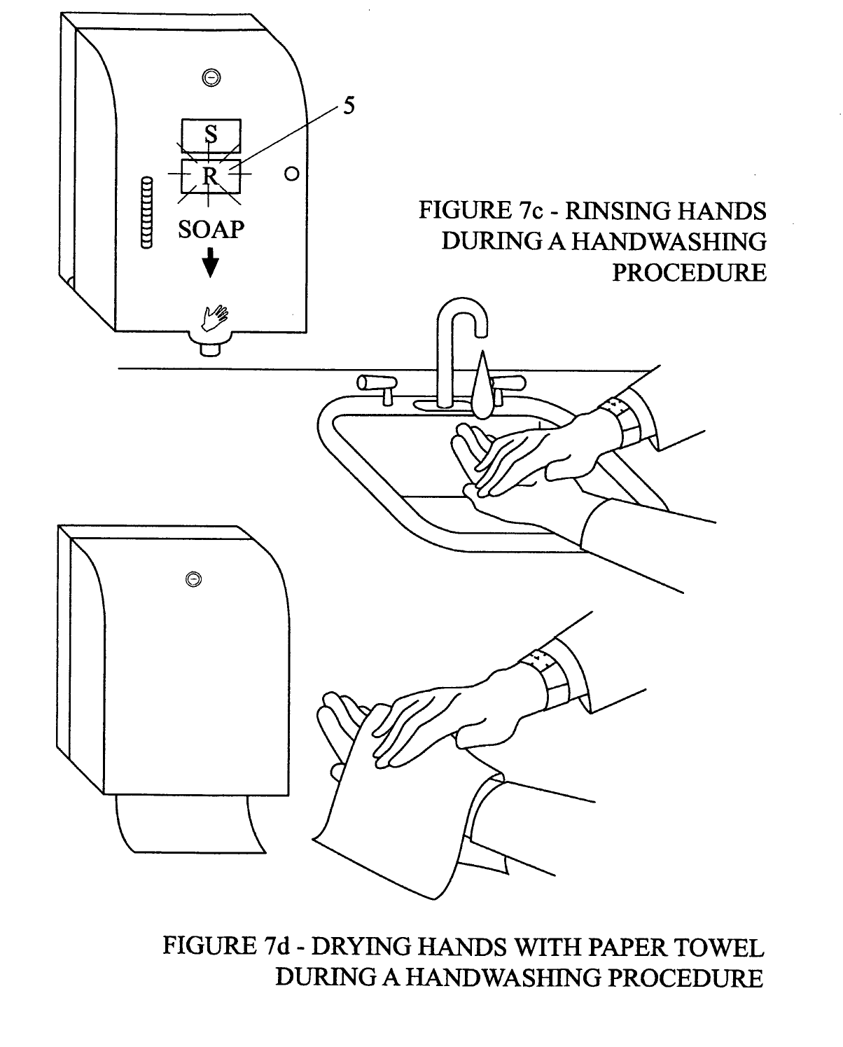

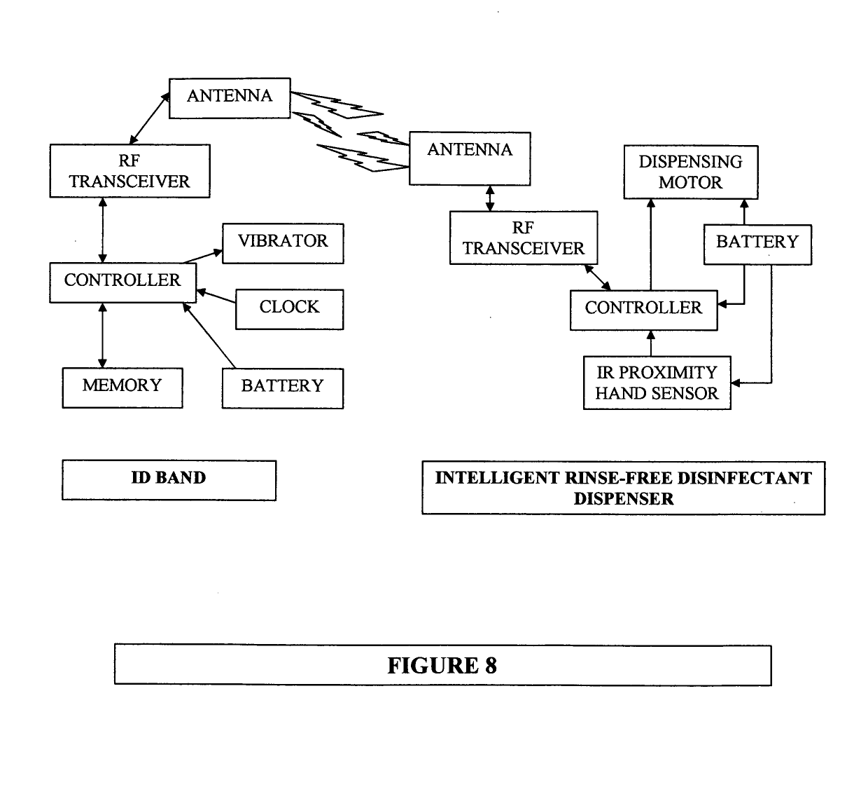

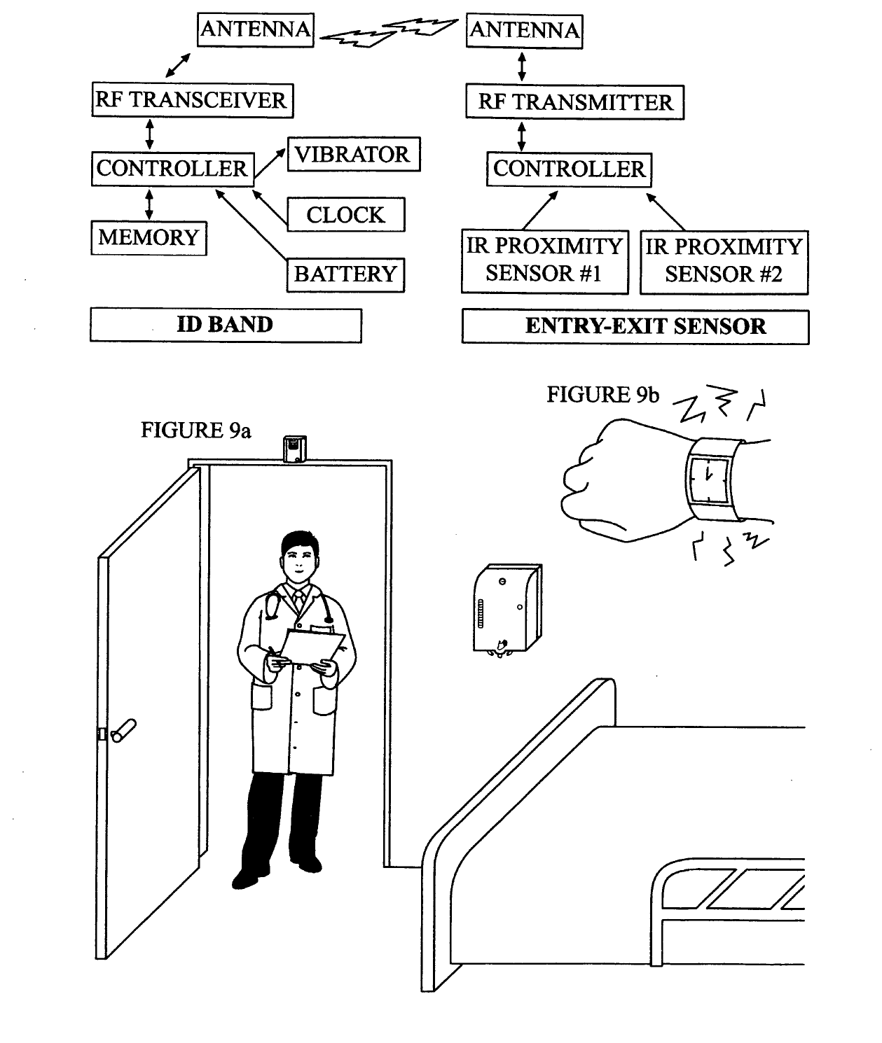

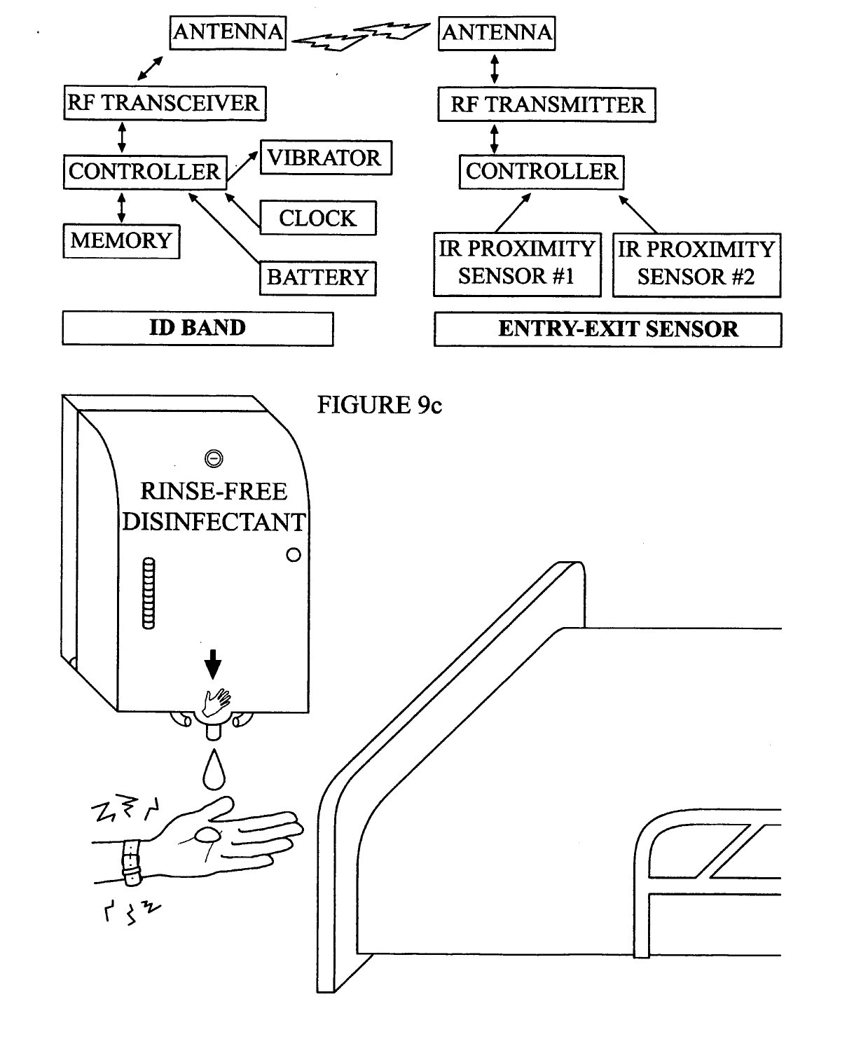

The intelligent controller board of the soap dispenser will also start a timer from the moment the dispenser is triggered. Every 5 seconds, it will transmit a timing mark with the personnel ID code of the triggering ID band as the lead element (again, any ID band without its own personnel ID code as the lead element will unable to decipher these timing marks). It will do so until 5 to 6 timing mark signals are transmitted (the 25^{th} and/or 30^{th} second from the triggering of the dispenser). The number of timing marks can be altered to enforce longer hand scrubbing and rinsing as dictated by the institution implementing this invention. During the first 10 or 15 seconds period, the controller board will flash “SCRUB” on the display panel (4 in FIGS. 1a, 1b and 7b) on the front of the dispenser; then it will flash “RINSE” on the display panel (5 in FIGS. 1a, 1b and 7c) for the next 10 or 15 seconds period. Again, the amount of time for scrubbing and rinsing can be customized by the institution implementing this proactive hand hygiene monitoring system. The ID band of the person undergoing the handwashing procedure will record these timing marks to signify that the wearer has or has not gone through the proper handwashing steps, i.e. at least 10 seconds of scrubbing with soap and 10 seconds of rinsing with water before walking away from the wash basin. The 5 and/or 6 (or more) timing marks constitute the second piece of data of a handwashing event.

The third piece of data is performed by the ID band of the person undergoing the handwashing procedure. Upon receiving the 5 and/or 6 timing marks, it will assign a “Pass” grade and duration of 30 seconds to the event. If the last two timing marks (the 20^{th}/25^{th} or 25^{th}/30^{th} second) are missing, then a “Fail” grade and duration of less than 20 seconds is recorded for this event. After issuing the 5^{th} or 6^{th} timing mark, the controller board will enter the soap dispenser into standby mode to conserve battery power.

Occasionally, a person may want additional soap aliquot after the initial dispensing; the intelligent controller board will treat the second dispensing as a single handwashing event if the demand of second aliquot occurs within 2 seconds of the first one. All the subsequent timing marks and transmitting of signal will still be based on the timing of the first dispensing and on the personnel code of the ID band already read. However, if the dispensing triggering is occurred after 2 seconds, then the intelligent controller will read the ID band code again to see whether its is still the same person. If it is the same person, the above described process will be continued. If it is not the same person, the controller board will run a parallel operation of two persons washing hands almost at the same time at the same wash basin. Again, there is no confusion of data recorded by prospective ID band, since the dispenser will issue its own ID codes and timing marks with two separate personnel ID band codes as lead elements.

A pulsed infrared proximity sensor mounted on the front of the soap dispenser (7 in FIGS. 1a and b) will sense people within its 4-5 ft or longer detection range. Upon sensing a person, it will activate the RF transceiver to broadcast a proactive “CHECK” signal (identical to the one that an Entry-exit sensor sends). Any person wearing an ID band within 4-5 ft of the soap dispenser will receive this signal, and his/her ID band will check the last time he/she had washed or cleaned hands. If the designated time length (determined by the institution's hand hygiene guidelines) is exceeded, then the ID band will issue a prompt (vibration or low tone) to remind the person walking by the wash basin to wash. If a prompt is issued, compliance and non-compliance is recorded by the if) band with time-date. If no hand hygiene action is required, then no record is entered. This approach makes the proactive prompting and monitoring totally transparent to the worker to eliminate any disruption of his/her work routine when no action is required. Since each person has his/her ID band, it will react to the prompt independently, therefore, the number of persons present next to the wash basin and the soap dispenser will not influence its effectiveness in prompting individual worker to comply to the hand hygiene guideline.

### 3. Monitoring Hand Cleaning With Rinse-Free Disinfectant

A person wearing his/her ID band undergoing a hand cleaning procedure will place his/her hand wearing the ID band under the rinse-free disinfectant dispenser to trigger its infrared proximity sensor (10 in FIG. 2a) for activating the dispensing motor as well as the intelligent controller board within. The active ID band will be transmitting at very low power (in 1 to 3 microwatts range, thus the signal can only be read by a dispenser's RF transceiver circuitry at no greater than 10 inches in distance) its personnel ID code at 2 Hz or faster repetition rate continuously along with the data on the last time the wearer washed or cleaned his/her hands.

While the dispensing motor is turning (or during the depressing of the manual dispensing tab-11 in FIG. 2b), the intelligent controller board is activated to receive the personnel ID code from the ID band along with the data of last time the wearer washed or cleaned his/her hands. At the very unlikely happening that two different people place their hands within 10 inches of the same rinse-free disinfectant dispenser, its intelligent controller board will pick the ID code belonging to the person having the longer time lapse from his/her last hand hygiene event. The dispenser's controller board then adds this ID band code as the lead element on a signal string including its own dispenser ID codes to transmit back to the ID band. This transmission is at higher power (at 2 to 3 milliwatts range) and 2 Hz or higher repetition rate for duration of 2 seconds to enable an ID band to receive this signal at a distance up to 4 ft. Any other person wearing an ID band standing next to the person who just dispensed disinfectant or walking by within the 4-5 ft radius will not be able to decipher the identification code of the rinse-free disinfectant dispenser, since it does not have the same personnel ID code in the lead element. The ID band of the person undergoing the hand cleaning procedure will record the identification code of the dispenser along with the time-date from its own internal programmable clock circuitry to constitute a hand cleaning event.

Occasionally, a person may want additional aliquot of disinfectant after the initial dispensing; the dispenser's intelligent controller board will treat the second dispensing as a single hand cleaning event if the demand of second aliquot occurs within 2 seconds of the first one. If the dispensing triggering is occurred after 2 seconds, then the controller-RF transceiver will read the ID band code again to see whether its is still the same person. If it is the same person, no further action will be taken. If it is not the same person, then the controller board will treat the second dispensing as a separate hand cleaning event and transmit another series of its dispenser code with the second personnel ID code as the lead element.

A pulsed infrared proximity sensor mounted on the front of the rinse-free dispenser (12 in FIGS. 2a and b) will sense person(s) within its 4-5 ft (or longer) detection range. Upon sensing person(s), it will activate its RF transceiver to broadcast a proactive “CHECK” signal (identical to the one sent by an entry-exit sensor). Any person wearing ID band will receive this signal, and the ID band will check the last time the person has washed or cleaned hands. If the designated time length is exceeded, then the ID band will issue a prompt (vibration or low tone) to remind the person walking by the dispenser to clean his/her hands. If a hand cleaning event is resulted or is needed but without responding action by that person, then the prompting will be part of the recorded data by the ID band with time-date. If no cleaning is required, then no recording is entered. This approach, again, makes the proactive prompting and monitoring totally transparent to the worker to eliminate any disruption of his/her work routine when no action is required. Since each person has his/her ID band, it will react to the prompt independently, therefore, the number of persons present next to the dispenser will not influence its effectiveness in prompting individual workers to comply to the hand hygiene guideline.

### 4. Monitoring Hand Hygiene in the Controlled Access Area

An entry-exit sensor (13 in FIG. 3a) mounted inside of a door frame (14 in FIG. 3a) of a controlled access area, such as a patient room, has two pulsed infrared beams aimed at two angles (15 and 16 of FIG. 3b), for example, one vertically downward and one slightly aiming inside of the room. Upon entry, a person will first interrupt the vertical beam then the angled bean next; while exiting, a person will first trigger the beam aiming inside of the room before interrupt the vertical downward beam. When the entry-exit sensor has its two pulsed infrared beams triggered sequentially, it will broadcast a RF “CHECK” command, its identification code and the code for entry or exit within 0.5 second of the triggering. The broadcast will last 1.5 seconds at 2 Hz of repetition rate and it can be detected by any ID band within 5-6 ft of the sensor.

Upon receiving this signal, an ID band will check the last time the wearer has washed or cleaned hands. If the designated time length is not exceeded, then only the entry-exit sensor's ID code along with time-date will be recorded by the ID band. If the designated time length is exceeded, then the ID band will issue prompt (vibration or a low tone) to remind the person entering or exiting to clean his/her hands. If no dispenser identification code is received by this ID band by the 5^{th} second from the prompt, it will issue the second prompt. If there is still no dispenser ID code received within 5 seconds after the 2^{nd} prompt, then the event will be recorded by the ID band with time-date and a code for “failure to respond”.

Since each person has his/her ID band, it will independently react to the “CHECK” command from the entry-exit sensor as well as whether to issue a prompt, therefore, the number of persons walking into or out of a room or already present within a room will not influence the effectiveness of entry-exit sensor to prompt individual workers to comply to the hand hygiene guideline.

### 5. Hand Hygiene Compliance Data Collection and Reporting

There can be two configurations of this data transfer station: one that handles multiple ID bands (FIG. 5a) and one that handles a single ID band (FIG. 5b). After working his/her shift, a worker can place his/her ID band into one of the multiple slots (18 of FIG. 5a) of the data transfer station or the single port station (typically located in individual physician and head nurse offices). The charging circuit of the station will start charging the internal battery of the ID band (17 of FIG. 4 illustrates the charging contacts), while the station through its antenna (located beneath the base of every docking port) will issue command to the docked ID band to identify itself and begin transfer its stored data to the station via radio frequency. The station after knowing the ID code of the band will display the person's name on the LCD panel next to the data transfer port (19 of FIGS. 5a and b) belonging to the ID band to facilitate the person to pick up his/her ID band next day.

The station will receive the data from each ID band sequentially and check the data integrity. If any error occurs, the station will ask the ID band to re-transmit. After verifying all the received data, the station will convert them into TCP/IP format and store it in its memory. The station will later transfer these stored data via existing or dedicated network of the facility to the central computer. The station also sends a clock synchronization command to each ID band docked on it at the completion of the data transfer process.

At a preset time interval(s), the data transfer station lid (20 of FIGS. 5a and b) is closed (automatically or manually) and the UVC lamps (21 of FIGS. 5a and b) are turned on for a 40-second (or longer) sterilization cycle. A safety latch (22 of FIGS. 5a and b) prevents opening of the lid while the UVC lamps are on.

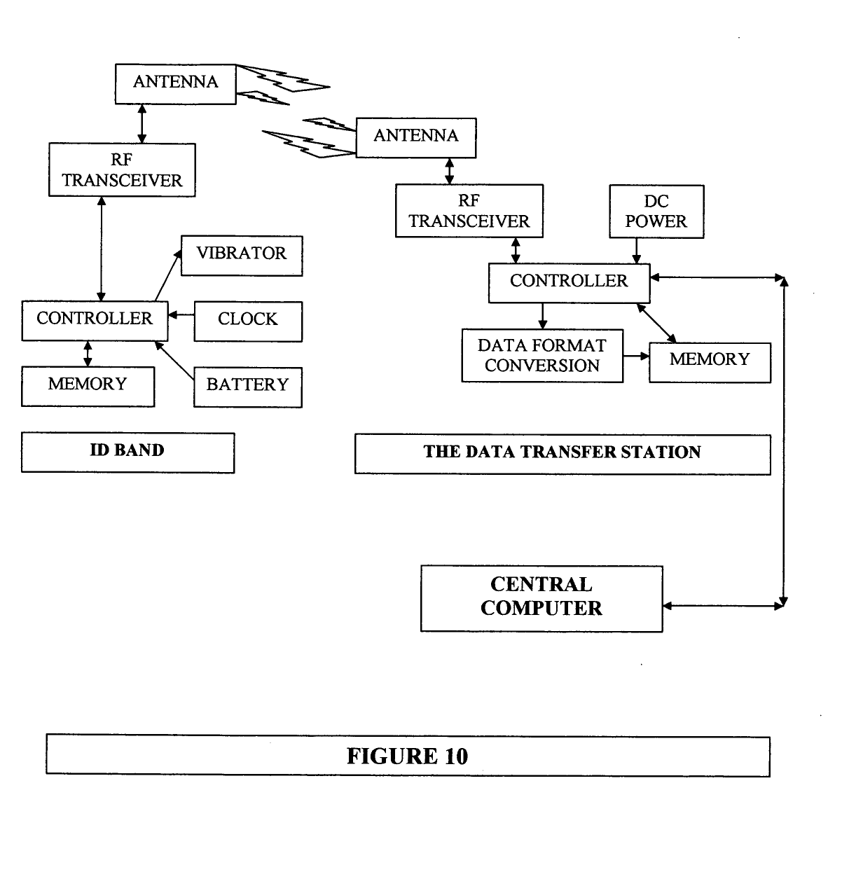

At a preset time interval(s) (such as 3:00AM each day or at end of each shift), the central computer will prompt each data transfer station to transfer its collected data sequentially to it for processing. Commercially available database software package, like SQL or Oracle, will be used to archive all the data, process it and perform statistical analysis into various hand hygiene reporting formats (FIG. 10 as an example) that an institution may desire. At the end of the data transferring process between each data transfer station and the central computer, a clock synchronization command will be issued by the central computer to each station to assure all the clocks are within one second of each other. This synchronization is also propagated to each ID bands to insure every timing data is in sync with the central computer to ascertain the accuracy of the hand hygiene compliance report.

Furthermore, the central computer will examine each “fail to response” record of a person by locating his/her hand hygiene event immediately after the non-response event to determine whether the person simply preferred to wash or clean his/her hands at a specific location or prior to his/her next task. If so, then the negative record will be removed. This procedure further reduces the interruption of one's regular work routine.

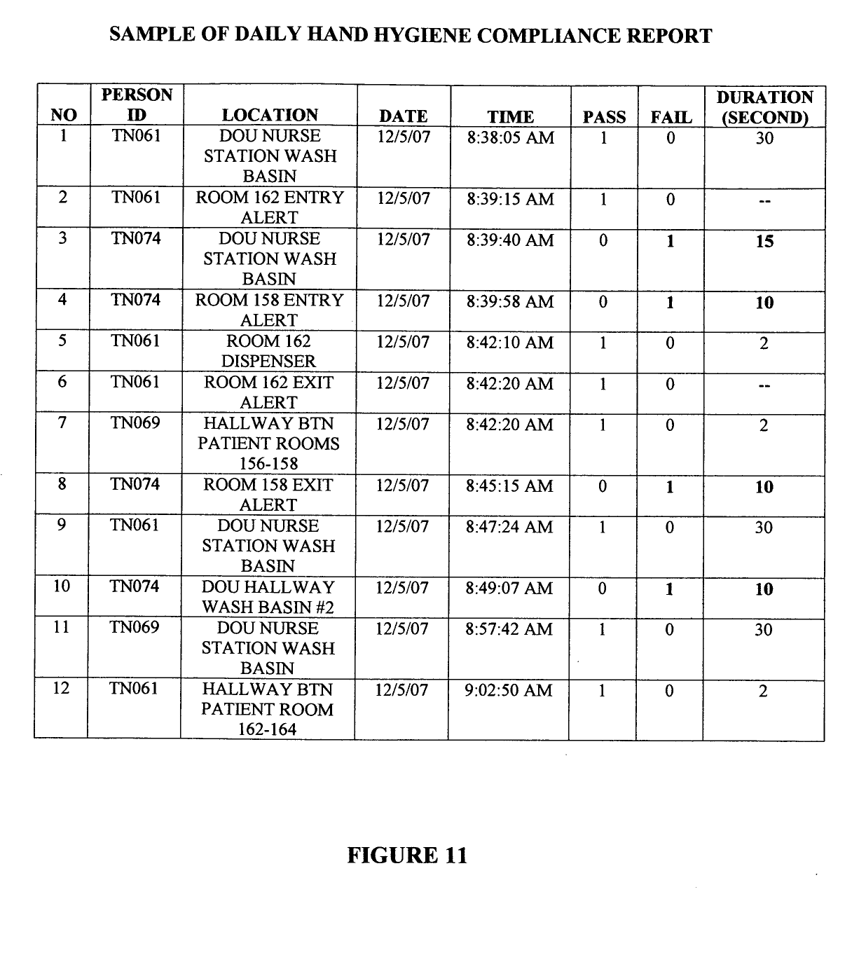

In FIG. 11, the conceptual daily hand hygiene compliance report illustrates that in the Definitive Observation Unit (DOU) of an arbitrary hospital, there are three nurses on duty during the day shift. Nurse with ID code TN061 started her handwashing in the wash basin located at the nurse station of DOU at 8:38:05 AM on Dec. 5, 2007, and her handwashing event was a “Pass”. She later walked into patient room 162 at 8:39:15 AM to care for the patient. The entry-exit sensor of room 162 signal her ID band for a proactive check, and since her last handwashing was just 20 seconds prior, there was no prompt issued by her ID band. After handling the patient, nurse with ID code TN061 performed a hand cleaning using the rinse-free disinfectant dispenser located in room 162 at 8:42:10 AM prior to her exit from the room, so the exit alert issued by the entry-exit sensor of room 162 at 8:42:20 AM was just noted by her ID band without issuing a prompt to clean her hands.

On the contrary, nurse with ID code TN074 did a cursory handwashing in the nurse station wash basin at 8:39:40 AM and dashed off to room 158 to care for a patient. The entry-exit sensor of room 158 alerted her ID band, which verified that her last handwashing was a “fail” and thus issued a prompt for her to clean her hands immediately at 8:39:58 AM. Unfortunately, nurse with ID code TN074 failed to respond to the two prompts issued 5 seconds apart and did not use any disinfectant dispenser in room 158 or just outside room 158 at 8:45:15 AM or about that time to clean her hands prior to handling the patient. She ignored the exit prompt from room 158 to clean her hands. Later on, nurse with ID code TN074 repeated her error in handwashing at DOU hallway wash basin #2 at 8:49:07 AM.

The infection control director of the hospital or the head nurse of this DOU section can readily single out nurse with ID code TN074 to request her to improve; equally, nurse with ID code TN061's record exemplifies full compliance to the hand hygiene guideline of the hospital. Furthermore, this daily hand hygiene compliance report can be formatted and/or color coded per each hospital's requirements.

### 6. Maintenance and Malfunction Diagnostics

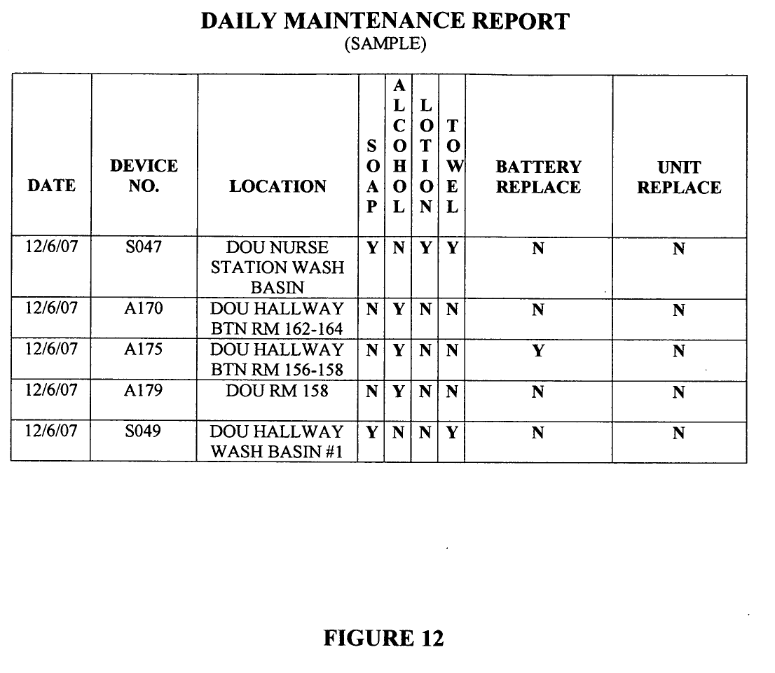

Since hand hygiene monitoring system is only good if every component is functioning correctly and the necessary soap/disinfectant/paper-towel is available in their respective dispensers. The invention presented here includes a cumulative counter in each soap and rinse-free disinfectant dispenser, which will account for the amount of soap or disinfectant dispensed along with amount of paper towel already used (as well as the amount of hand lotion dispensed, if such dispenser is mounted at every wash basin). At a preset level, the dispenser will issue a refill request signal transmitted along with its dispenser ID codes. Every person using that dispenser will have his/her ID band record this request, which will later be transferred to the central computer to issue a daily maintenance report as illustrated in FIG. 12.

The circuitry of every device of this invention has the function of measuring the power level supplied by its internal batteries. If a voltage drop off is detected, a request signal for replacement will be issued along with its ID codes for the receiving ID bands to transfer the request to the central computer for maintenance action.

The first row of the table in FIG. 12 shows that soap, lotion and towel refills are needed for the wash basin located in the nurse station at the DOU section. The battery for the soap dispenser is O.K. and the unit is functioning correctly.

The second row shows it is a rinse-free disinfectant dispenser located on the hallway between patient room 162 and 164 in the DOU section that requires an alcohol gel refill but nothing else.

The third row shows that the rinse-free disinfectant dispenser located on the hallway between patient room 156 and 158 in DOU requires a battery replacement.

We claim:

1. A proactive hand hygiene monitoring system that employs interactive radio frequency identification (RFID) technology in the personnel identification tag: (a) to monitor handwashing and hand cleaning with rinse-free disinfectant, (b) to determine the thoroughness of handwashing procedure undertaken, (c) to proactively prompt workers to clean their hands based on their recorded hand hygiene history and tasks at hand. The system is used to optimize the compliance by workers in the effort of reducing or eliminating cross infection that occur frequently in healthcare settings, food service and processing facilities, hotels, cruise lines, spas/fitness centers/gyms, schools and homes.

2. The system described in claim 1 consists of multiple units of the following components:
(1) An identification tag, in the form of a wrist band or wrist watch (ID band in short), assigned to each personnel to be monitored, which uses active RFID technology to interact (transmit and receive signals) with the pre-programmed soap and rinse-free disinfectant dispensers as well as entry-exit sensors to record the time-date (generated by an internal programmable clock circuitry of the ID band) of each of his/her hand hygiene event and its thoroughness. Based on the stored record and notification from a dispenser or entry-exit sensor, the ID band will also proactively prompt (by either vibration or low tone) the wearer to conduct hand cleaning prior to perform the next task, such as handling the next patient.
(2) Pre-programmed soap and rinse-free disinfectant dispensing (wall-mounted and counter top placed) units which will notify the user's ID band via radio frequency of their own unique identification codes after triggering by the user.
(3) Entry-exit sensors using dual pulsed infrared or RF emitter-detector cones aiming at slight angle from each other to detect entry or exit of controlled access areas by one or more persons and inform the persons' ID bands via radio frequency to record the time-date of the unique identification codes of that sensor.
(4) Data transfer stations which will download the recorded data from every personnel ID band placed on their ports. They will verify the data integrity and convert them into a format (such as TCP/IP for Ethernet) to transmit via wired or wireless network to the central computer. They will also charge the internal battery of the docked ID band to maintain its functionalities.
(5) A central computer (which can be a personal computer or a server) which will receive the collected data from all the data transfer stations and processing them into a daily and/or periodic hand hygiene compliance report. It will also query the maintenance conditions of each component of this system (such as soap and rinse-free disinfectant refills as well as battery power level) and perform diagnostic to detect any malfunctions. During the data collection process, it will synchronize its clock with all the ID bands to assure the entire system is in synchronization with respect to timing of all events. It will also archive all the collected data and information.

3. The personnel identification tag described in claim 2, in which it can be in the form of a wrist band or wrist watch to be worn on the hand that receives soap or rinse-free disinfectant aliquot from a dispenser during a handwashing or cleaning procedure.

4. The wrist band or the integral band carrying the wrist watch as described in claim 3 can be composed with material impregnated with very small (such as nano size) silver particles as an antibacterial agent to allow the band to remain germ-free.

5. The system described in claim 1 will further use the following method to accurately identify the person undergoing hand hygiene process:
(1) All the personnel identification band/watch (ID band in short) employed with this invention will transmit its unique identification code via radio frequency (such as at 2.4 GHz) at 1 Hz or higher repetition rate continuously and at power level of a few microwatts, i.e. the code can only be detected by a built-in antenna in a pre-programmed dispenser within a few inches from an ID band.
(2) In a handwashing case, a soap dispenser's controller circuitry will be activated by either the infrared proximity sensor sensing the presence of a hand underneath its dispensing nozzle (touchless version) or by depression of the dispensing tab (manual version). It will then read the personnel identification code transmitted by the ID band worn on the wrist of the person undergoing the handwashing procedure. It will be unable to read identification codes transmitted by other ID bands since the dispenser will be outside of the transmitting signal strength of those ID bands (10 inches or greater in distance to the dispenser). The dispenser will add this unique personnel identification code of the ID band as the leading element on its transmission signal string, which consists of the dispenser's own identification code (to determine its type and location). The transmission will be at 1 Hz or higher repetition rate for a period of 2 seconds or less and at power level of a few milliwatts to enable any ID bands within 3 to 4 ft of the dispenser to detect this series of transmission.
(3) In hand cleaning case, a rinse-free dispenser's controller circuitry will be activated by either the infrared proximity sensor sensing the presence of a hand underneath its dispensing nozzle (touchless version) or depressing of the dispensing tab (manual version). It will then read the personnel identification code transmitted by the ID band worn on the wrist of the person undergoing the hand cleaning procedure, and it will add this unique code as the leading element on its transmission signal string, which consists of the dispenser's own identification code (to determine its type and location). The transmission will be at 1 Hz or higher repetition rate for a period of 2 seconds or less and at power level of a few milliwatts to enable any ID bands within 3 to 4 ft of the dispenser to detect this series of transmission.
(4) Every ID band employed has an imbedded instruction set which allows it to decipher only the RF signal with its own individual unique personnel identification code as the lead element. Therefore, only the ID band, worn by the person undergoing the handwashing or cleaning, can detect and decipher the signal string broadcasted by the dispensers.
(5) The ID band of the person undergoing handwashing or cleaning will record the soap or rinse-free disinfectant dispenser's identification code along with time-date into its memory as a hand hygiene event. Since no other person's ID band can respond to the dispenser's transmitting data string without his/her ID code as the leading element, so no other person's ID band can record this dispensing as a handwashing or cleaning event.

6. The system described in claim 1 can also employ the following method to accurately identify the person undergoing hand hygiene process:
(1) All the personnel identification bands employed with this invention will transmit its unique personnel identification code via a specific radio frequency (for example at 2.433 GHz) at 1 Hz or higher repetition rate continuously and at power level of a few microwatts, i.e. the code can only be detected within a few inches of the ID band. The imbedded instruction set within each ID band will operate its built-in RF transceiving circuitry at the specific frequency (say 2.433 GHz) unless it has been told to switch to a second frequency (such as 315 MHz or some slight shift in frequency from 2.433 GHz) for transceiving a preset length of time.
(2) In handwashing case, the soap dispenser's controller circuitry will be activated by either the infrared proximity sensor sensing the presence of a hand underneath its dispensing nozzle (touchless version) or by the depressing of the dispensing tab (manual version). It will then read the identification code transmitted (say at 2.433 GHz frequency) by the ID band worn on the wrist of the person undergoing the handwashing procedure. It will unable to read identification codes transmitted by other ID bands since the dispenser will be outside of the transmitting signal strength radius of those ID bands (10 inches or greater in distance to the dispenser). The personnel identification code serves as a trigger for the dispenser to transmit a signal to this particular ID band immediately (such as within 1 second) at weak signal strength of a few microwatts to dictate the ID band to switch to a second frequency (such as 315 MHz or some slight shift in frequency from 2.433 GHz) for further transceiving. The dispenser will then send its own identification code (for determination of its type and location) at the second frequency and at 1 Hz or higher repetition rate for the duration of a proper handwashing routine as well as at power level of a few milliwatts to enable any ID bands within 3 to 4 ft of the dispenser to detect this transmission.
(3) In hand cleaning case, the rinse-free dispenser's controller circuitry will be activated by either the infrared proximity sensor sensing the presence of a hand underneath its dispensing nozzle (touchless version) or the depressing of the dispensing tab (manual version). It will then read the personnel identification code transmitted by the ID band worn on the wrist of the person undergoing the hand cleaning procedure. The dispenser will transmit a signal to this particular ID band immediately (such as within 1 second) at weak signal strength of a few microwatts to dictate it to switch to a second frequency (such as 315 MHz or some slight shift in frequency from 2.433 GHz) for further transceiving. The dispenser will then send its own identification code (for determination of its type and location) at the second frequency and at 1 Hz or higher repetition rate for a duration of 2 seconds as well as at power level of a few milliwatts to enable any ID bands within 3 to 4 ft of the dispenser to detect this transmission.
(4) Every ID band employed has an imbedded instruction set which allows it to switch to a second RF frequency (when instructed by a dispenser's signal) for transceiving during the subsequent time period before switching back to the first RF frequency. Therefore, the ID band worn by the person undergoing the handwashing or cleaning will communicate with the soap or the rinse-free disinfectant dispenser exclusive of all other persons' ID bands.
(5) The ID band of the person undergoes handwashing or cleaning will thus record the soap or rinse-free disinfectant dispenser's identification code along with time-date supplied by its internal clock circuitry into its memory as a hand hygiene event without the possibility of being mis-identified.

7. The method described in claim 5 or 6 for providing accurate identification of the person undergoes hand hygiene procedure can be further supplemented with the following method during a handwashing or cleaning event when more than one person presented hands to a dispenser:
(1) All the personnel identification band/watch (ID band in short) employed with this invention will transmit its unique identification code and the time of last executed hand hygiene event via radio frequency at 2 Hz repetition rate and at power level of a few microwatts, i.e. the code can only be detected within a few inches of the ID band.
(2) When the RF circuitry of the dispenser detects more than one ID bands, the controller board will select the one with the longest time from last executed hand hygiene as the person undergoes the current hand hygiene event. It will then use this identification code as the lead element of its transmission signal string as described in claim 5 or requesting the ID band to switch to the second RF frequency for the subsequent communication as described in claim 6.
(3) For the handwashing event, the soap dispenser can further ensure the ID band selected under this described rare occasion is indeed the correct person by issuing its subsequent 5 timing marks (at 5 seconds apart) with alternating personnel ID code as lead element in the data string (i.e. the primary ID code selection is added to the first timing mark, then follows with the second choice ID code in front of the second timing mark and so on). Any ID band records show these skipped timing marks while with or without the dispenser identification code will all be given credit that handwashing event was executed by this person.

8. The system described in claim 1 can achieve its proactive prompting of the workers to undergo hand hygiene at appropriate time or occasion by the following method:
(1) Entry-exit sensor using dual pulsed infrared or RF emitter-detector cones aiming at slight angle from each other is employed to detect personnel entering into or exiting from a controlled access area, such as a patient room, a restroom, a surgery room or raw meat processing station.
(2) Upon detection of person(s) entering or exiting, the sensor will transmit a RF “CHECK” signal as the lead element followed by its own sensor identification code.
(3) An ID band, with a proper instruction set, worn by any person entering or exiting controlled access areas will receive and record the “CHECK” signal and the identification code of the entry-exit sensor along with time-date from its own internal programmable clock circuitry into its memory. It will also immediately examine its own memory for the time of the last hand hygiene event. If the time period is within a designated period (determined either by the institution implementing this hand hygiene monitoring system or preset at a specific value), then there is no further action. If the time period is longer than the designated period or the last handwashing result had a “Fail” grade, then this ID band will issue a prompt (in vibration or low tone) to alert the person to undergo hand cleaning before executing any task where cross infection can occur.
(4) 5 seconds after issuing the first prompt, the ID band will issue the second prompt (again, in vibration or low tone) if it has not received any dispenser identification code (which indicates the person has not responded to the first prompt). 5 seconds after the 2^{nd} prompt without getting any dispenser identification code, the ID band will record the event and issue a “Fail to respond” grade. Any dispenser identification code received by this ID band code as the lead element of the signal string will indicate proper response has been made by the person and will be recorded as such in his/her ID band's memory.
(5) If the ID band determines the last time proper hand hygiene has been performed is within the designated time period after receiving a “CHECK” signal from an entry-exit sensor, then no prompt will be issued and only the time-date as well as the sensor identification code will be recorded by the ID band.

9. The system described in claim 1 can further achieve its proactive prompting of the workers to undergo hand hygiene at appropriate time or occasion by the following method:
(1) Every soap and rinse-free disinfectant dispenser is equipped with a pulsed infrared or RF proximity sensor on its front cover. This sensor will detect any person within its detection cone of 4 to 5 ft of distance (or longer).
(2) Upon detecting a person, the dispenser will send out a RF “CHECK” signal similar to the one sent out by an entry-exit sensor described in claim 8 part (2).
(3) The ID band, worn by any person walking by a dispenser, which receives the “CHECK” signal, will immediately examine its memory for the time of last hand hygiene event. If the time period is longer than a designated period or the last handwashing result had a “Fail” grade, then the ID band will issue a prompt (in vibration or low tone) to alert the person to undergo hand cleaning before proceeding.
(4) 5 seconds after issuing the first prompt, the ID band will issue the second prompt if it has not received any dispenser identification code (which indicates the person has not responded to the prompt). 5 seconds after the 2^{nd} prompt without getting any dispenser identification code, the ID band will record the event and a “Fail to respond” grade. Any dispenser identification code received with this ID band code as the lead element of the signal string will indicate proper response has been made by the person and will be recorded as such in his/her ID band memory.
(5) If the ID band examination of last time proper hand hygiene has been performed is within the designated time period after receiving a “CHECK” signal from any dispenser, then no prompt will be issued nor any recording of this event will be made by the ID band.
(6) When the instruction set residing in the central computer examines the hand hygiene data transmitted by an ID band, it will flag all the “Fail to respond” events and examine whether the person has performed a hand hygiene event after each “Fail to response” record within a specified time frame. If yes, then the “Fail to response” mark will be erased.

10. The system described in claim 1 can further employ the following method to guide and monitor the handwashing procedure (as recommended by the CDC) to assure thorough handwashing is done:
(1) Upon the dispensing of the soap, the dispenser's controller will start a timer.
(2) It will transmit a timing mark signal every 5 seconds for a period of 25 seconds or longer.
(3) Each of the timing mark signals will have the personnel code of the ID band of the person undergoing the handwashing procedure as the lead element, so only this person's ID band can receive, decipher and record these timing marks.
(4) During the first 10 second period (adjustable time length to as long as 20 seconds), the controller will flash a “SCRUB” display (which may be located on the front of the soap dispenser cover or as an independent unit) to remind the person undergoing the handwashing procedure to scrub his/her hands vigorously for the duration as stated in CDC handwashing guidelines.
(5) During the next 10 second period (again, adjustable time length), the controller will flash a “RINSE” display (which may be located on the front of the soap dispenser cover or as an independent unit) to remind the person to rinse his/her hands thoroughly as prescribed by CDC guidelines.
(6) When the person's ID band records all 5 or more timing marks, it will then assign a “Pass” grade to this handwashing event. Missing the final two timing marks (the 4^{th} and 5^{th} in the 25-second scheme) will result a “Fail” grade for this event to be recorded.

11. The system described in claim 1 can be used to produce a daily and/or periodic hand hygiene compliance reports on each employee, each department and/or each shift of a facility which implemented this system. The report can include the whereabouts of the employees at what time and whether he/she had performed proper hand hygiene procedures before executing his/her assigned tasks as well as whether he/she had ignored proactive prompting.

12. The reports described in claim 11 can be further linked to other data available to the institution that has implemented this invention, such as patients that have hospital acquired infection (HAI) or food born illnesses traced back to a food processing plant. As an example, by the linkage, a hospital or nursing home can trace whether or not healthcare workers took care or had exposure to those HAI patients and examine the hand hygiene compliance record of those workers to determine which worker may be responsible for the HAI outbreak and what other patients may be at risk of HAI due to exposure to the same healthcare worker.

13. The reports described in claim 11 can be used as a part of performance criteria to penalize and/or promoting/rewarding workers.

14. The reports described in claim 11 can also be linked to the profit and loss data of an institution that has implemented this invention to view the relationship with respect to hand hygiene compliance by its workers.

15. The radio frequencies utilized in the system described in claim 1 are those permitted under the U.S. Federal Communication Commission for short distance communication without special licensing or permission at low power, such as 2.4 GHz, 2.433 GHz, 315 MHz, etc.

16. The components of the system described in claim 2 can all be powered by battery, with the exception of the central computer, to provide flexibility in location and ease of installation into a facility.

17. The personnel ID bands in conjunction with the data transfer stations as described in claim 2 can further serve as the linkage of all the soap dispensers, rinse-free disinfectant dispensers and entry-exit sensors to the central computer without any wired or wireless inter-connections among them.

18. The soap and rinse-free disinfectant dispensers of the system described in claim 2 can further employ circuitry to measure the amount of soap or disinfectant that has been dispensed. With this measurement, the dispenser can issue requests for refill by adding a code into the signal string it sends out to ID bands during hand hygiene procedures. By employing the ID bands to communicate the request for refill through the data transfer stations to the central computer, a daily refill order with the types of refills and the locations of the dispensers can be issued to the person or department responsible for such a ask.

19. The soap and rinse-free disinfectant dispensers along with the entry-exit sensors of the system described in claim 2 can further employ circuitries to measure the voltage level derived from their internal battery. With this measurement, the dispenser can issue a request for replacement by sending additional codes to ID bands during hand hygiene monitoring processes. By employing the ID bands to communicate the request for battery replacement through the data transfer stations to the central computer, a daily battery replacement order with the types and the locations of the components can be issued to the person or department responsible for such task.

20. Based on the system described in claim 1, there is a paper towel dispenser and maybe a hand lotion dispenser located next to each wash basin. Although they are not equipped with a pre-programmed controller and RF transceiver circuitry as the soap dispensers, their refill requirements can be linked to the soap dispenser usage. Therefore, this linkage, in the form of mathematical ratios, can be used by the central computer to issue daily refill orders for paper towel and hand lotion for specific wash basin.

21. The personnel ID bands in conjunction with the data transfer stations described in claim 2 can further be used as a clock-in and clock-out device for employees. When a worker picks up his/her ID band from a data transfer station at the beginning of his/her work shift, the station can record the ID code and the time. At the end of a shift, the person will place his/her ID band into one of the ports of a data transfer station, which will immediately identify the person and register the time of his/her shift end. The central computer will relay this work time-sheet data to an appropriate software package used by the institution implementing this invention.

22. The data transfer station described in claim 2 can also include a cover with ultraviolet lamps to produce light in the UVC wavelength (253.7 nm) region to sterilize all of the ID bands docked in the station periodically.

23. The data transfer station described in claim 2 can also include electromagnetic interference shielding for each individual ID band docking port to prevent data corruption during the transferring process between an ID band and the station.

24. The data transfer station described in claim 2 can also use contact-less electromagnetic energy transfer method to charge the internal batteries of the ID bands placed in its docking port, thus eliminating the alignment of contacts to achieve charging.

25. The system described in claim 1 can also include the ID bands that are worn on the ankle of the workers with a dispenser's triggering sensor mounted remotely at the ankle level. This configuration may be applicable to facilities equipped with foot controlled faucets for wash basins.

26. The entry-exit sensors employed in claim 2 can further be used to track the patient care and/or workload of the healthcare workers during his/her shift.

27. All the ID bands in claim 2 will undergo daily clock synchronization with the central computer through the data transfer station to assure accurate hand hygiene compliance monitoring and reporting.

28. A proactive hand hygiene monitoring system that employs a combination of passive radio frequency identification (RFID) and interactive radio frequency transceiving techniques in a personnel identification tag: (a) to monitor handwashing and hand cleaning with rinse-free disinfectant, (b) to measure the thoroughness of handwashing procedure undertaken, (c) to proactively prompting the workers to clean their hands based on their recorded hand hygiene history and tasks at hand. This system is used to optimize the compliance by workers in the effort of reducing or eliminating cross infection occur frequently in healthcare settings, food service and processing facilities, hotels, cruise lines, spas/fitness centers/gyms, schools and homes.

29. The personnel identification tag described in claim 28 can be in the form of a wrist band or wrist watch to be worn on the hand that receives soap or rinse-free disinfectant aliquot from a dispenser during a handwashing or cleaning procedure.

30. The system described in claim 28 can consist of multiple units of the following components:
(1) An ID band (assigned to each personnel to be monitored) uses passive RFID technology to transmit its unique personnel ID code to the pre-programmed dispensers while using a battery-powered active RF transceiver circuit to interact with the pre-programmed soap and rinse-free disinfectant dispensers as well as entry-exit sensors to record the time-date (generated by an internal programmable clock circuitry of the ID band) of each of the wearer's hand hygiene event and its thoroughness. This personal ID band also consists of an imbedded instruction set for it to decipher signals from the dispensers only with its own unique ID code as the leading element. In addition, the ID band will, based on the stored record and dispenser or entry-exit sensor notification, proactively prompt (by vibration or low tone) the wearer to conduct hand cleaning prior to perform the next task, such as handling the next patient.
(2) Pre-programmed soap and rinse-free disinfectant dispensing (wall-mounted and counter-top-placed) units will charge the passive RFID circuitry within an ID band for it to transmit one-time its unique personnel ID code. Upon receiving this ID code, the dispenser will transmit its own identification code (to provide information on its type, i.e. soap dispenser or rinse-free disinfectant dispenser, and location) with the received personnel ID code as the leading element of the RF transmitting signal string.
(3) Entry-exit sensor using dual pulsed infrared or RF emitter-detector cones aiming at slight angle from each other is employed to detect the entry or exit of a controlled access area of one or more persons. It will issue to the persons' ID bands via radio frequency a “CHECK” command along with its own unique sensor identification code (which represents its location) for the receiving ID bands to determine whether hand hygiene is needed prior to the ID band wearer performing the next task.
(4) A data transfer station which will download the recorded data from every personnel ID band placed in its ports. It will verify the data integrity and convert them into a format (such as TCP/IP for Ethernet) to transmit via wired or wireless network to the central computer. It will also charge the internal battery of the ID band to maintain its functionalities.
(5) A central computer (which can be a personal computer or a server) which will receive the collected data from all the data transfer stations and processing them into a daily and/or periodic hand hygiene compliance report. It will also query the maintenance conditions of each component of this system (such as soap and rinse-free disinfectant refills as well as battery power level) and perform diagnostic to detect any malfunctions. During the data collection process, it will synchronize its clock with all the ID bands to assure the entire system is in synchronization with respect to timing of all events. It will also archive all the collected data and information.

31. The system described in claim 28 will use the following method to accurately identify the person undergoing hand hygiene process:
(1) A personnel identification band/watch (ID band in short) employed with this invention includes a passive RFID circuitry, which will transmit its unique identification code via a specific radio frequency one time upon its charging capacitor being energized remotely by the antenna integrated within a soap or rinse-free disinfectant dispenser. Since this remote electromagnetic charging can only be accomplished within a short distance (a few inches) from the charging antenna, no other passive RFID circuitries located within other ID bands on the persons standing nearby will be charged up to transmit their ID codes. Therefore, the reading device integrated within the soap or rinse-free disinfectant dispenser can receive only the ID code of the person undergoing soap or disinfectant dispensing and will exclude other persons standing or walking nearby.
(2) In a handwashing case, the soap dispenser's controller circuitry will be activated by either the infrared proximity sensor sensing the presence of a hand underneath its dispensing nozzle (touchless version) or by the depressing of the dispensing tab (manual version). It will transmit electromagnetic energy to charge up the passive RFID circuit in the ID band worn on the wrist of the person undergoing soap dispensing for this passive RFID circuit to transmit its identification code just one time. The dispenser's RF transceiver circuitry will read this personnel identification code broadcast by the passive RFID circuit, then add this unique identification code of the ID band as the leading element on the dispenser's outward series of transmission signal strings, which consists of the dispenser's own identification code (to determine its type and location). This outward transmission will be at 1 Hz or higher repetition rate and at power level of a few milliwatts to enable any ID bands within 3 to 4 ft of the dispenser to detect this transmission. This transmission may be at a different frequency from the passive RFID transmission frequency.
(3) In hand cleaning case, the rinse-free dispenser's controller circuitry will be activated by either the infrared proximity sensor sensing the presence of a hand underneath its dispensing nozzle (touchless version) or by the depressing of the dispensing tab (manual version). It will transmit electromagnetic energy to charge up the passive RFID circuit in the ID band worn on the wrist of the person undergoing rinse-free disinfectant dispensing for this passive RFID circuit to transmit its identification code just one time. The dispenser will then read the personnel identification code transmitted by the ID band worn on the wrist of the person undergoing the hand cleaning procedure, and it will then add this unique code as the leading element on its outward transmission signal strings, which consists of the dispenser's own identification code (to determine its type and location). The transmission from the dispenser will be at 1 Hz or higher repetition rate and at power level of a few milliwatts to enable any ID bands within 3 to 4 ft of the dispenser to detect this transmission. Again, this transmission may be at a different frequency from the passive RFID transmission frequency.
(4) Every ID bands employed has an imbedded instruction set which allows it to decipher only the RF signal with its own individual unique personnel identification code as the lead element. Therefore, the ID band worn by the person undergoing the handwashing or cleaning will detect the signal string broadcasted by the dispensers and decipher the data string since it has its own code as the leading element of the detected signal string. Equally, all other ID bands worn by people near the person undergoing hand hygiene event will not be able to decipher the transmitting signals from dispensers, since their unique personnel ID codes are not the lead element of those signals.
(5) The ID band of the person undergoing handwashing or cleaning will record the soap or rinse-free disinfectant dispenser's identification code along with a time-date from its own internal programmable clock circuitry into its memory as a hand hygiene event.

32. The system described in claim 28 can achieve its proactive prompting of the workers to undergo hand hygiene at appropriate time or occasion by the following method:
(1) Entry-exit sensor using dual pulsed infrared or RF emitter-detector cones aiming at slight angle from each other is employed to detect personnel entering into or exiting from a controlled access area, such as a patient room, a restroom, a surgery room or raw meat processing station.
(2) Upon detection of person(s) entering or exiting, the sensor will transmit a RF “CHECK” signal as the lead element followed by its own identification code.
(3) The ID band worn by any person entering or exiting a controlled access area will receive and record the “CHECK” signal along with the identification code of the entry-exit sensor and the time-date in its memory. It will also immediately examine its own memory for the time of last hand hygiene event. If the time period is within a designated period (determined by the institution implementing this hand hygiene monitoring system or a preset value), then there is no further action. If the time period is longer than the designated period or the last handwashing result had a “Fail” grade, then the ID band will issue a prompt (in vibration or low tone) to alert the person to undergo hand cleaning before executing any task, such as caring for a patient.
(4) 5 seconds after issuing the first prompt, the ID band will issue a second prompt if it has not received any dispenser's identification code (which indicates the person has not responded to the first prompt). 5 seconds after the 2^{nd} prompt without getting any dispenser's identification code, the ID band will record the event and a “Fail to respond” grade. Any dispenser's identification code received with this ID band code as the lead element of the signal string will indicate proper response has been made by the person and will be recorded as such in his/her ID band memory.
(5) If the ID band examination of last time proper hand hygiene has been performed is within the designated time period after receiving a “CHECK” signal from the entry-exit sensor, then no prompt will be issued and only the time-date as well as the sensor identification code will be recorded by the ID band.

33. The system described in claim 28 can further achieve its proactive prompting of the workers to undergo hand hygiene at appropriate time or occasion by the following method:
(1) Every soap and rinse-free disinfectant dispenser is equipped with a pulsed infrared or RF proximity sensor on its front cover. This sensor will detect any person within its detection cone of say 4 to 5 ft (or longer) of distance.
(2) Upon detecting a person, the dispenser will send out a RF “CHECK” signal similar to the one sending out by the entry-exit sensor described in claim 32 part (2).
(3) The ID band worn by any person walking by the dispenser and receives the “CHECK” signal, will immediately examine its memory for the time of last hand hygiene event. If the time period is longer than a designated period or the last handwashing result had a “Fail” grade, then the ID band will issue a prompt (in either vibration mode or a tone mode) to alert the person to undergo hand cleaning before proceeding.
(4) 5 seconds after issuing the first prompt, the ID band will issue a second prompt if it has not received any dispenser identification code (which indicates the person has not responded to the prompt). 5 seconds after the 2^{nd} prompt without getting any dispenser identification code, the ID band will record the event and a “Fail to respond” grade. Any dispenser identification code received with this ID band code as the lead element of the signal string will indicate proper response has been made by the person and will be recorded as such in his/her ID band memory.
(5) If the ID band examination of last time proper hand hygiene has been performed is within the designated time period after receiving the “CHECK” signal from the dispenser, then no prompt will be issued nor any recording of this prompt will be made by the ID band.
(6) When the instruction set residing in the central computer examines the hand hygiene data transmitted by an ID band, it will flag all the “Fail to respond” events and examine whether the person has performed a hand hygiene event after each of “Fail to response” record within a specified time frame. If yes, then the “Fail to response” mark will be erased.

34. The system described in claim 28 can further employ the following method to guide and monitor the handwashing procedure to assure thorough washing has occurred per CDC handwashing guideline:
(1) Upon dispensing of soap, a dispenser's controller will start a timer.
(2) It will transmit a timing mark signal every 5 seconds for a period of 25 seconds or longer.
(3) Each of the timing mark signals will have the personnel code of the ID band of the person undergoing the handwashing procedure as the lead element, so only this person's ID band can receive, decipher and record the marks.
(4) During the first 10 second or longer period (adjustable length in time by changing the imbedded instruction set), the controller will flash a “SCRUB” display (which may be located on the front of the dispenser cover or as an independent unit) to remind the person undergoing the handwashing procedure to scrub his/her hands vigorously for the duration.
(5) During the next 10 second or longer period (again, adjustable length in time by changing the imbedded instruction set), the controller will flash a “RINSE” display (which may be located on the front of the dispenser cover or as an independent unit) to remind the person to rinse his/her hands thoroughly for the duration.
(6) When the person's ID band records all 5 timing marks (or more), it will then assign a “Pass” grade to this handwashing event. Missing the last two timing marks (the 4^{th}, 5^{th} timing marks in the 25-second scenario) will result a “Fail” grade for this event to be recorded.

35. The ID bands employed in claim 28 can have its passive RFID circuitry completely independent to the battery-powered active RF transceiver and controller circuitry of the ID band. It can also be located at a different site on the band.

36. The system described in claim 28 will be used to produce daily and/or periodic hand hygiene compliance reports on individuals, departments and shifts. The reports can include the whereabouts of the employees at what time and whether he/she had performed proper hand hygiene procedures before executing his/her assigned tasks as well as whether he/she had ignored proactive prompting.

37. The system described in claim 28 can also produce the daily and/or periodic hand hygiene compliance reports that are linked to other data sources such as a patient's name and patient room number where hospital acquired infection have taken place to pinpoint the workers that may be responsible for any cross infections.

38. The radio frequency utilized in the system described in claim 28 are those permitted under the U.S. Federal Communication Commission for short distance communication without special licensing or permission at low power, such as 134 KHz, 315 MHz, 915 MHz, 2.4 GHz, etc.

39. The personnel ID Bands in conjunction with the data transfer stations as described in claim 30 can further serve as the linkage of all the soap dispensers, rinse-free disinfectant dispensers and entry-exit sensors to the central computer without any wired or wireless inter-connection among them.

40. The system described in claim 29 can also include the ID bands that are worn on the ankle of the workers with dispenser's triggering sensor mounted remotely at the ankle level. This configuration may be applicable to facilities equipped with foot controlled faucets for wash basins.

41. The wrist band or the integral band carrying the wrist watch as described in claim 29 can be composed with material impregnated with very small (nano size) silver particles as antibacterial agent to allow the bands to remain germ-free.

42. The usage of the system described in any preceding claims (1-41) in the healthcare facilities (hospitals, nursing care facilities, outpatient clinics, physician offices, dialysis centers, dental clinics and other medical diagnostic facilities) to monitoring the compliance of their staff with respect to handwashing and hand cleaning guidelines set out by relevant government agencies and professional associations for the reduction of cross infection incidences with said healthcare entity.

43. The usage of the system described in any preceding claims (1-41) in the food processing and delivery entities, lodging industry, cruise ships, spas, fitness centers, gyms, schools and homes to monitoring the compliance of their staff with respect to handwashing guidelines set out by relevant government agencies for the reduction of community acquired infections as well as food borne illness caused by non-compliance of the workers or members within said facilities.
